(19) United States
(12) Patent Application Publication
(10) Pub. No.: US 2005/0076364 A1
(43) Pub. Date: Apr. 7, 2005

(54) System and method for customizing a multimedia interface

(76) Inventors: Derek Dukes, San Jose, CA (US); Valla Vakili, Sunnyvale, CA (US); Hamid-Reza Behhnam-Dehkordy, Redwood City, CA (US); Matthew Rowlen, San Mateo, CA (US)

Correspondence Address: IRELL & MANELLA LLP, 840 NEWPORT CENTER DRIVE, SUITE 400, NEWPORT BEACH, CA, 92660, US

(21) Appl. No.: 10/752,824

(22) Filed: Jan. 6, 2004

Related U.S. Application Data
(60) Provisional application No. 60/498,899, filed on Aug. 29, 2003.

(51) Int. Cl. H04N 7/173; H04N 5/445; G06F 13/00; H04N 7/16; G06F 3/00

(52) U.S. Cl. 725/46; 725/109; 725/110; 725/45; 725/131; 725/150

(57) ABSTRACT

Disclosed is a system and method for providing and experiencing broadcast and non-broadcast content. One aspect of the invention is to provide a way for a user to customize available broadcast content, as well as available non-broadcast content and services. In one embodiment, an online user interface is used to set a plurality of user preferences and settings which tailors and formats the non-broadcast content and services available via a client-side device.

### CROSS REFERENCE TO RELATED APPLICATIONS

This application is related to and claims priority from provisional application Ser. No. 60/498,899, entitled “System and Method for Integrating Data with Broadcast Content,” filed on Aug. 29, 2003.

### BACKGROUND OF THE INVENTION

1. Field of the Invention

The present invention relates in general to a system and method for integrating personalized data, services, content and community with broadcasted, recorded and/or downloaded content. More particularly, the present invention relates to user customization of a multimedia interface.

2. Background of the Invention

Currently, the television viewing experience is a homogenous experience devoid of virtually any personalization. While users may be able to identify and choose from a set of favorite channels, there are few additional means in which a user may personalize their TV experience.

In contrast, substantial strides have been taken to personalize the online experience. For example, by registering with a given website, users are often able to customize the look and feel of the site. Similarly, users are often given options to specify what type of content they would like presented to them.

Unfortunately, there is no current way to customize a user's TV viewing experience. There is also no effective way to transfer user experiences between mediums like PCs, TVs, etc. Available content and services are currently medium-specific. Accordingly, there is a need in the art to not only provide a customized TV viewing experience, but also a TV viewing experience that incorporates a user's online preferences and habits into their TV experience. There is also a need in the art for making content and services ubiquitous between various mediums, and to deliver content and services to differing user interfaces and devices.

### BRIEF SUMMARY OF THE INVENTION

A system and method for customizing a multimedia interface is disclosed. In one embodiment, a system includes a user computer coupled to a data network, where the user computer displays a user interface usable to access a user account to enter a plurality of user customization preferences that are associated with said user account. The system further includes a client-side device coupled to the data network, where the client-side device receives non-broadcast data from the data network and broadcast programming content from a broadcast source. In one embodiment, the client-side device accesses the plurality of user customization preferences from the user account via the data network, displays a plurality of media presentation options based on the plurality of user customization preferences from the user account, and accesses selected broadcast programming content from the broadcast source based on a user selection from the plurality of media presentation options.

Other embodiments are disclosed herein.

### BRIEF DESCRIPTION OF THE DRAWINGS

FIGS. 1A-1C depict simplified system diagrams of one or more aspects of the invention, according to one or more embodiments.

FIGS. 2A-2C depict additional system-level embodiments of one or more aspects of the invention;

FIGS. 3A-3B are flow diagrams of how a client device request may be processed, according to one or more embodiments;

FIGS. 4A-4B depicts one or more embodiments of a system-level diagram of various aspects of the invention, showing the interconnectivity relating thereto;

FIG. 5A is one embodiment of a diagram showing some of the functions and services that are accessible through an online user interface;

FIG. 5B is one embodiment of the online user interface of FIG. 5A;

FIG. 5C illustrates another embodiment of the online user interface of FIG. 5A;

FIG. 5D illustrates one embodiment of the Electronic Programming Guide provided through the use of the online user interface of FIG. 5C;

FIG. 5E illustrates one embodiment of the Schedule Recordings provided through the use of the online user interface of FIG. 5C;

FIG. 5F illustrates one embodiment of the Preferences menu provided in accordance with the online user interface of FIG. 5C.

FIG. 6A is one embodiment of a diagram showing an application tree structure that may implement one or more aspects of the present invention;

FIGS. 6B-6D depict one or more embodiments of display screens for display on a broadcast-based system with which a user may interact;

FIGS. 7A-7B depict one or more embodiments of a program guide screenshot which implements one or more aspects of the invention;

FIGS. 8A-8B are embodiments of screenshots illustrating how a user may navigate through one or more aspects of the invention;

FIG. 9 illustrates one embodiment of a graphical user interface which may be used to set one or more user preferences in accordance with the principles of the invention;

FIG. 10 is another embodiment of an online user interface usable to customize one or more screenshots that are accessible to a user;

FIGS. 11A-11E are embodiments of screenshots accessible to a user which have been customized using the online user interface of FIG. 10;

FIGS. 12A-12D are additional embodiments of screenshots accessible to a user which have been customized using the online user interface of FIG. 10; and

FIGS. 13A-13C are embodiments of screenshots accessible to a user to perform a search for indirectly related content.

### DETAILED DESCRIPTION OF EXEMPLARY EMBODIMENTS

A system and method for providing and experiencing broadcast and non-broadcast content is disclosed. One aspect of the invention is to provide a user with the ability to navigate a multimedia interface which simultaneously displays both broadcast and non-broadcast data. In one embodiment, a user is able to navigate television programming options, and selectively view detailed information on a selected programming option. In another embodiment, this detailed information includes at least one of critic information, actor information and related-content recommendations.

Navigation of the broadcast and non-broadcast content may be provided using a client-side device to which both the broadcast and non-broadcast content is provided. A series of menus and submenus may be usable to navigate an application tree of available services and data.

Another aspect of the invention is to provide a way for a user to customize available broadcast content, as well as available non-broadcast content and services. In one embodiment, an online graphical user interface is used to set a plurality of user preferences and settings which tailors and formats the non-broadcast content and services available via a client-side device. By entering user preferences, the online preferences and/or habits may be incorporated into a user's viewing experience, such as a television viewing experience or to utilize available services provided by website, a server or any other medium. Once the user's preferences have been specified, the user may access and/or incorporate his/her preferences in using available services, from any device that is connected to a network (such as a local area network, wide area network, a global network such as the Internet, etc.).

Another aspect of the invention is to provide content searching functionality for indirectly related content, and to enable user to view the indirectly related content that is found. For example, after entering a starting criteria (e.g., an actor's name) and an ending criteria (e.g., another actor's name), one embodiment would conduct a content search that establishes an indirect relationship between this starting criteria and ending criteria. In one embodiment, this indirect relationship may be a series of movies in which at least one common actor has appeared.

There is also currently no means for users to take their user experiences to different mediums like a personal computer, television etc. The data and content delivered is distinct among the various mediums. One embodiment of the invention bridges this gap by providing a method for making the data and content ubiquitous on the network. It provides a means to deliver content to differing user interfaces and devices while allowing the user to retain their personalization.

In accordance with the practices of persons skilled in the art of computer programming, the invention is described below with reference to symbolic representations of operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations such as in system memory, as well as other processing of signals. The memory locations where data bits are maintained are physical locations that have particular electrical, magnetic, optical, or organic properties corresponding to the data bits. Thus, the term “server” is understood to include any electronic device that contains a processor, such as a central processing unit.

When implemented in software, the elements of the invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

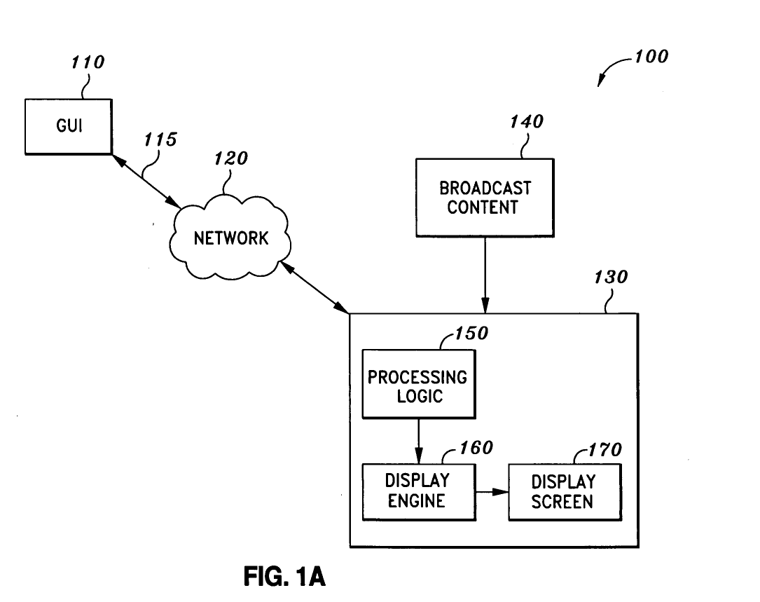

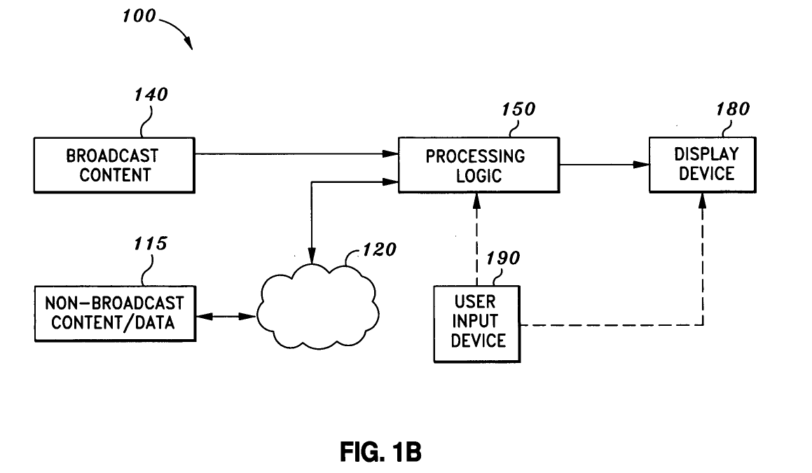

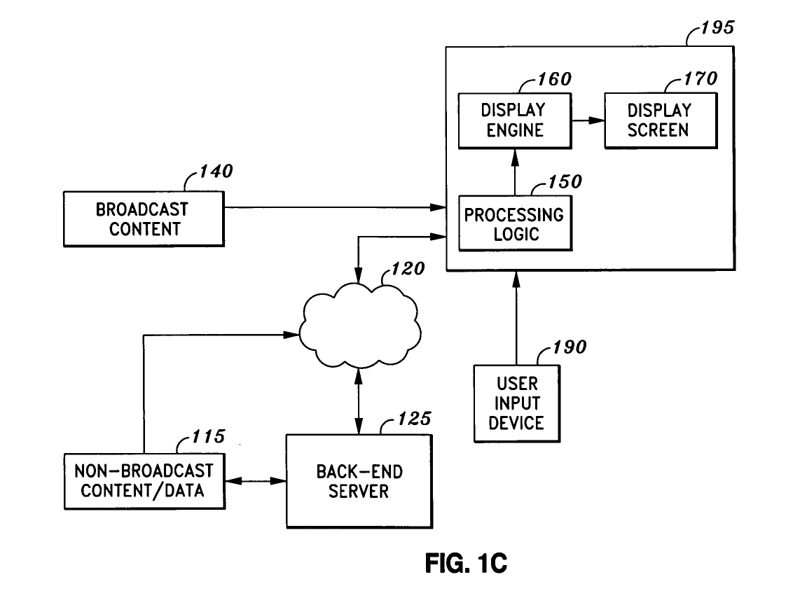

Referring now to FIG. 1A, system 100 includes GUI 110 which may be used to input user preferences and/or personalized information. Based on the user input from GUI 110, non-broadcast content/data 115 may then be communicated to a client-side system 130 over a network 120. It should of course be appreciated that non-broadcast content/data 115 may include user-preference data, multimedia content and any other form of non-broadcast data. In the embodiment of FIG. 1A, the client-side system 130 may also receive broadcast content 140 and allow for simultaneous presentation of both non-broadcast content 115 and broadcast content 140 within the same user experience. One embodiment of integrating non-broadcast content 115 and broadcast content 140 is described in co-pending U.S. patent application Ser. No. ______, entitled “System and Method for Integrating Broadcast and Non-broadcast Content,” filed on Jan. 6, 2004, which is assigned to the assignee of the present application, and incorporated herein by reference.

Continuing to refer to FIG. 1A, client-side system 130 is depicted as including processing logic 150, display engine 160 and display screen 170. While in one embodiment, processing logic 150 is a set-top box (STB) device, it should equally be appreciated that other connected devices with similar capabilities may be used to receive, decode and process both non-broadcast content/data 115 and broadcast content 140.

Processing logic 150 communicates with both network 120 and display engine 160, which may be used to render image/video for presentation on display screen 170. Thus, processing logic 150 may provide information back to a back-end system (not shown). In one embodiment, this information may relate to user viewing habits of broadcast content 140. While in one embodiment, display engine 160 and display screen 170 comprise a television, they may similarly comprise other broadcast-content-based display devices.

FIG. 1B depicts another embodiment of system 100 in which non-broadcast content/data 115 and broadcast content 140 are provided to processing logic 150, which in one embodiment may be a STB device. Processed image/video data may then be provided to display device 180. It should further be appreciated that processing logic 150 may further include recording functionality, such as the functionality provided by a digital video recorder (DVR). User input 190 may optionally be used to communicate with processing logic 150 and/or display device 180 for display control, channel selection, feature selection and the like. In one embodiment user input device 190 is a remote-control-type device. While in one embodiment user input device is a remote-control-type device, it may also be any other input means, such as a keyboard, voice recognition, touch screen, etc.

Referring now to FIG. 1C, yet another embodiment of system 100 is depicted. In this embodiment, non-broadcast content/data 115 and broadcast content 140 are provided to display device 195, which includes processing logic 150, display engine 160 and display screen 170. In one embodiment, display device 195 is a television with built in processing logic which provides the functionality for decoding and processing the incoming data streams. It should further be appreciated that DVR-type device (not shown) may be incorporated into display device 195 or, alternatively, coupled to display device 195. User input device 190 may then be used to make on-screen selections based on available menu options and/or available content.

While non-broadcast content/data 115 may be provided by other processing logic devices coupled to network 120 according to the user preferences entered via GUI 110, it may also come from a third-party online source (music database, movie trailer database, etc.) that is accessed in accordance with the various user selections and preferences entered via GUI 110. Moreover, non-broadcast content/data 115 may be provided to or from a back-end server 125 that is also coupled to network 120.

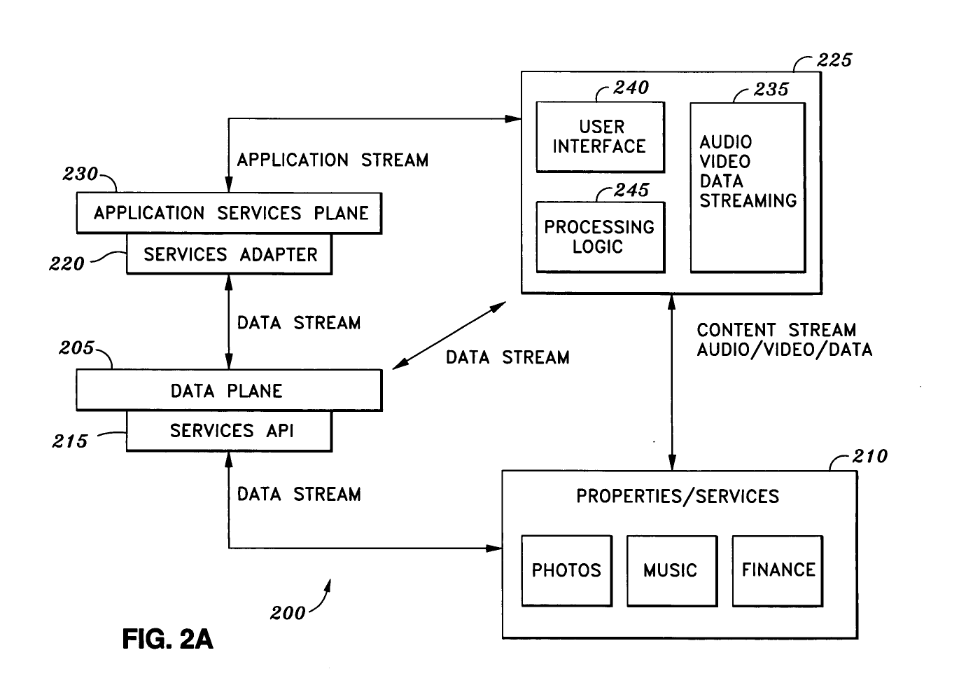

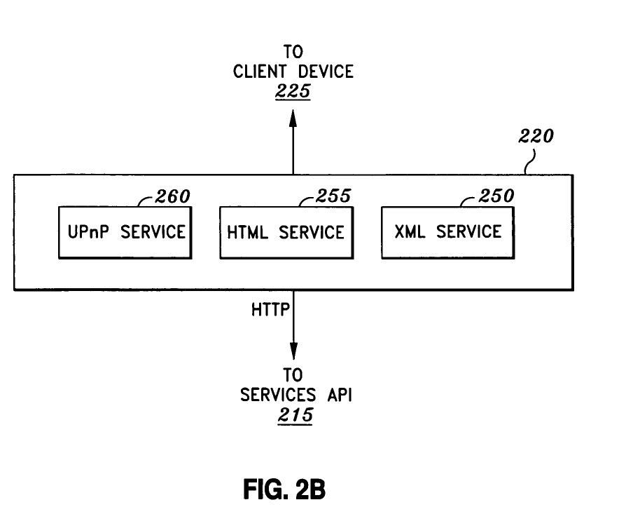

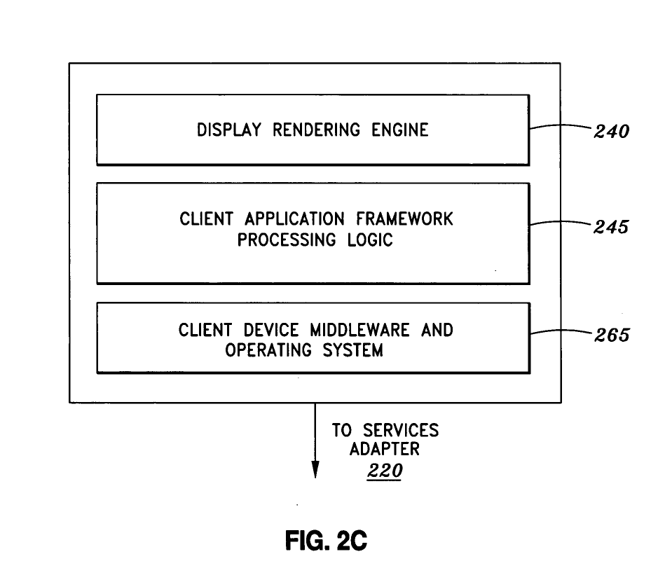

Referring now to FIG. 2A, system 200 is another embodiment of the invention in which properties/services element 210 delivers a service to a client-side device 225 (e.g., client-side system 130, processing logic 150, display device 195, etc.) via a data plane 205 and an application service plane 230 comprised of a services adapter 220. In one embodiment, the data plane 205 retrieves data from available properties/services 210 (e.g., content, services, etc.) via the Services API 215. In one embodiment, the Services API 215 may be used to provide uniform access to content and services from underlying properties/services 210. While the Services API 215 may be implemented via standard data protocols (e.g., PHP, XML, SOAP, etc.), other protocols may similarly be used as necessary to retrieve the data. The Services API 215 may function to wrap the existing properties/services 210 in a common interface or, alternatively, may provide a translation layer for external requests. For example, the internal communication between the Service API 215 and properties/services element 210 may be via PHP, while the external API may be via XML.

Continuing to refer to FIG. 2A, application service plane 230 is comprised of a services adapter 220 which may function as the entry point for all client-side requests. It should be appreciated that the service adapter 220 may reside either as a client adapter or directly on a back-end server (e.g., back-end server 125), or as an independent adapter connected via a network to both the data plane 205 and the client device 225. The services adapter 220 will be discussed in more detail below with reference to FIG. 2B. It should further be appreciated that the client device 225 may also directly retrieve a data stream from the Service API 215 via the Data Plane 205 if it has the capability to process the data directly. By way of example, an XML-aware device can directly request data from the Service API 215 relating to say stock quotes, and present it as appropriate in a proprietary user interface 240. The client device 225 may also directly communicate to the properties/services element 210 in order to stream content to it. For example, to send/receive audio stream from the Yahoo Launch or a video stream from Yahoo Movies.

FIG. 2A further depicts certain aspects of the client-side device 225 (as will be discussed in more detail below with reference to FIG. 2C), including the streaming audio/video 235 storage, proprietary user interface (UI) 240 and processing logic module 245. Referring now to FIG. 2B, one embodiment of certain aspects of a services adapter 220 is depicted. In particular, services adapter 220 is shown comprising an XML service module 250, HTML service module 255 and UPnP service module 260. The services adapter 220 may be responsible for i) acting as the point of interface between client-side devices and the Services API 215, ii) marshalling data from the data plane 205 based on client-side data requirements, and iii) applying the appropriate UI transformation as necessary on the returned data before forwarding to the client-side device. In one embodiment, the role of the services adapter 220 is to provide services to the client in any manner required using any protocol requires. The adapters (e.g., XML, HTML, UPnP, etc.) are only some examples of possible service adapters. Furthermore, the role of UI transformation may be done either in the service adapter 220 or directly on the client device 225 as appropriate for the device. In one embodiment, there may be multiple service adapters on a network responsible for different services. For example, a service adapter 220 catering to finance may be different from one delivering the movie content service. Alternatively, services adapters may be defined in terms of the delivery protocol. For example, the XML service adapter may be separate from a HTML service adapter and may cater to different client devices on the network.

Referring now to FIG. 2C, certain additional aspects of one embodiment of client-side device 225 are depicted. In one embodiment, the processing logic module 245 is a platform-specific application framework that is downloaded to the client device 225 as part of its bootstrap or resides in nonvolatile memory on the device and invoked during bootstrap. In another embodiment, the processing logic framework may be responsible for one or more of the following: i) handling client data requests and interacting with the services adapter 220; ii) handling platform-specific events such as remote and keyboard handling; iii) providing a device translation layer between device-specific functions and application services (e.g., setting device clock, getting client MAC address, etc.); and iv) formatting data appropriately for the display rendering engine 240. In one embodiment, for a client with a browser rendering engine, the process logic module 245 will construct the appropriate HTML with data retrieved from the service adapter 220. It should be noted that the nature and function of the process logic module 245 may be dependent on the client device 225 and may not exist on devices that do not require a framework. For example, on digital media receivers (DMR), the service adapter 220 may directly deliver data to a third party application module that presents the data appropriately to the user. Finally, the client-side device 225 of FIG. 2C may also include middleware and operating system 265.

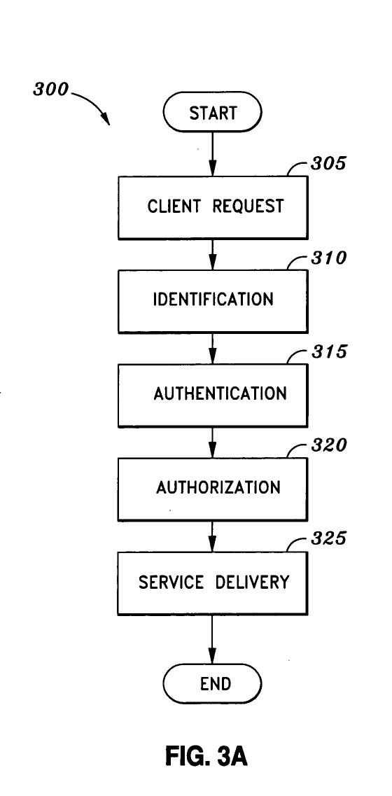

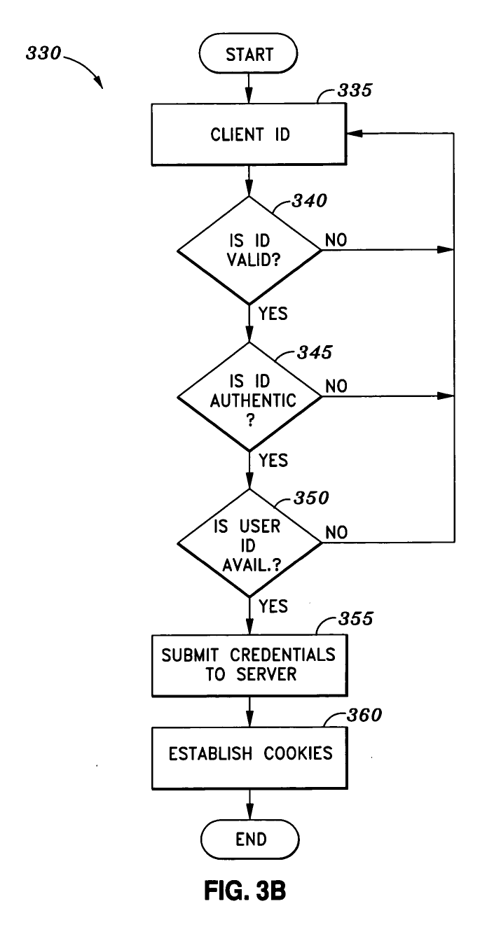

FIG. 3A depicts a simplified flow diagram for how a client device (e.g., client-side system 130) requests data and services. In the embodiment of FIG. 3A, request process 300 begins at block 305 when a client device (e.g., client-side system 130) submits a request, which in one embodiment may be submitted to back-end server 125. In another embodiment, the request made is sent to the data plane 205 via services adapter 220 as discussed above. Regardless of how the request is issued, request process 300 may then continue to block 310 where the client device is identified based on a device ID. In one embodiment, the client device may identify itself to the services adapter 220 using a unique ID string. While in one embodiment, the unique ID string is the Ethernet Media Access Control (MAC) address, it may also be a smart card address, wireless network address, CPU identifier, or simply an arbitrarily selected value.

Once the client device has been identified, the client device may then be authenticated at block 315. To that end, FIG. 3B is a flow diagram of one embodiment for the authentication process 330 of a client device. After the client device ID is provided at block 335, a validity determination may then be made at block 340. This may involve, for example, a determination that the provided device ID contains a particular number of characters or fits a particular data format. Once the ID is identified as valid, authentication process 330 may then continue to block 345 where a determination of the ID's authenticity is made. In one embodiment, this may involve mapping the client device ID against existing entries of a database, such as a database stored on back-end server 125. The use of certificates, encryption, hashing, secure sockets, and so on may also be used to prevent tampering with the device authentication. At this point, devices that have been authenticated may be provided with some privileges for accessing available data and services, but not necessarily all possible privileges. It should also be appreciated that invalid or unauthenticated device IDs may be provided with yet a more reduced level (e.g., guest level) of access privileges.

Once an ID has been identified and authenticated as described above, the client device may be able to obtain additional privileges and services by allowing a user to login. To that end, process 330 continues to block 350 where a determination may be made as to whether a user ID is available. On HTML-capable client-side devices 130 where the user input device 190 is a keyboard (or a device capable of keyboard entry), user's may be presented with a username/password entry dialog box. Alternatively, on HTML-capable client-side devices 130 with only remote control support, the user can be presented with a PIN entry dialog box. Finally, where the client-side device 130 is not HTML-enabled, user ID data may be submitted by the device to the Service Adapter 220 by another suitable means (e.g., an HTTP post). The Service Adapter 220 may then perform the necessary data submission to the back-end server 125 on behalf of the client-side device 130.

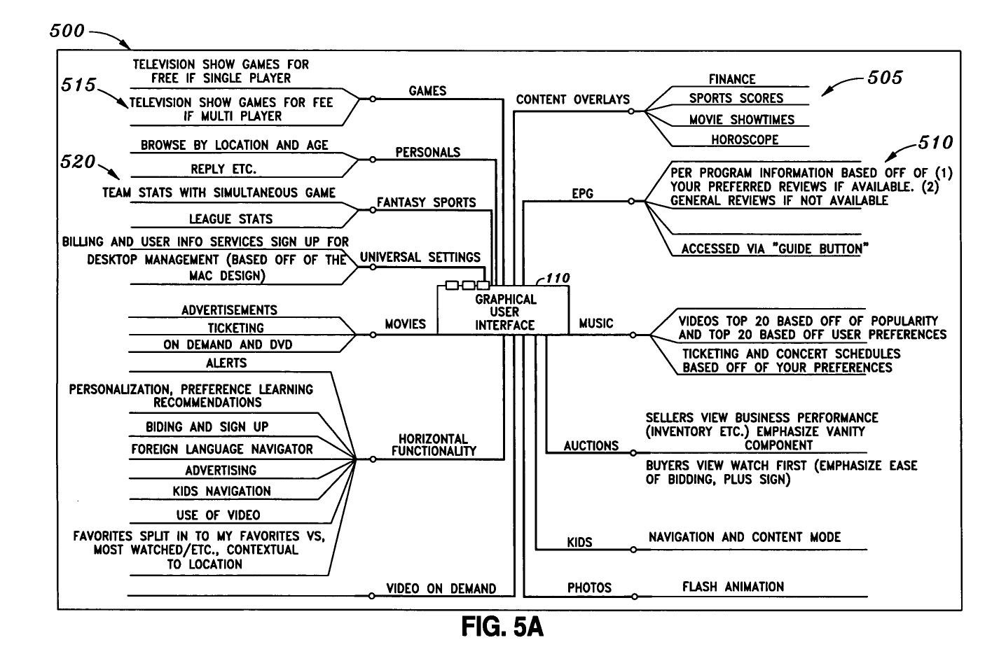

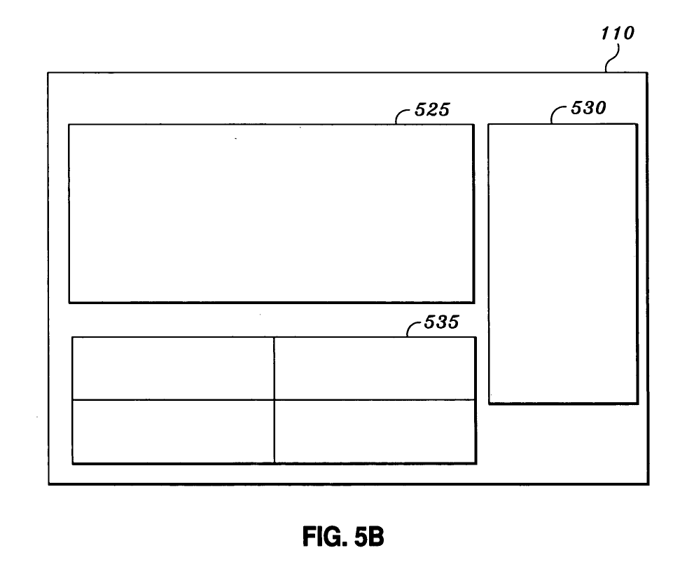

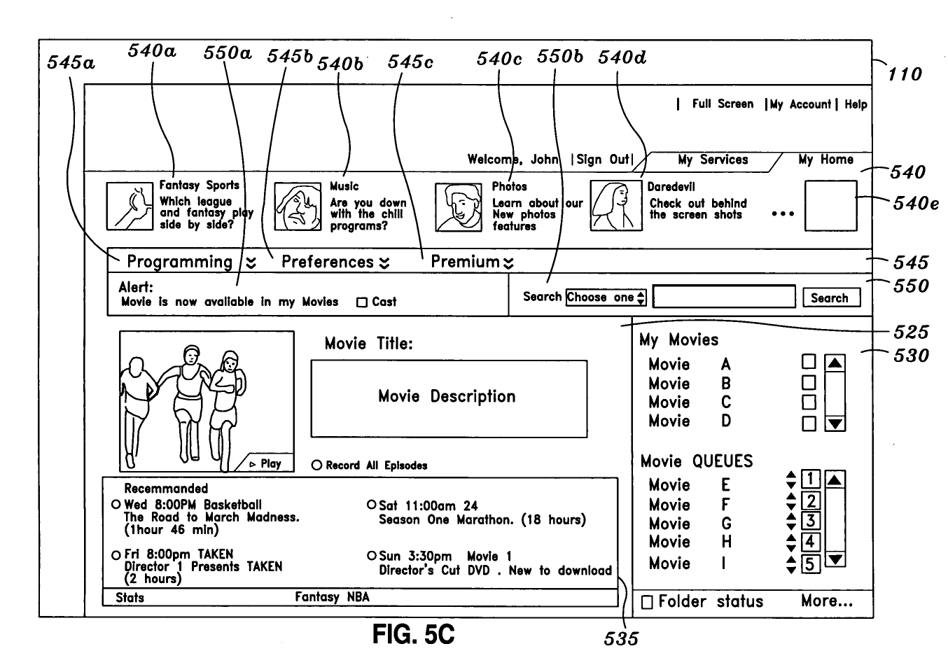

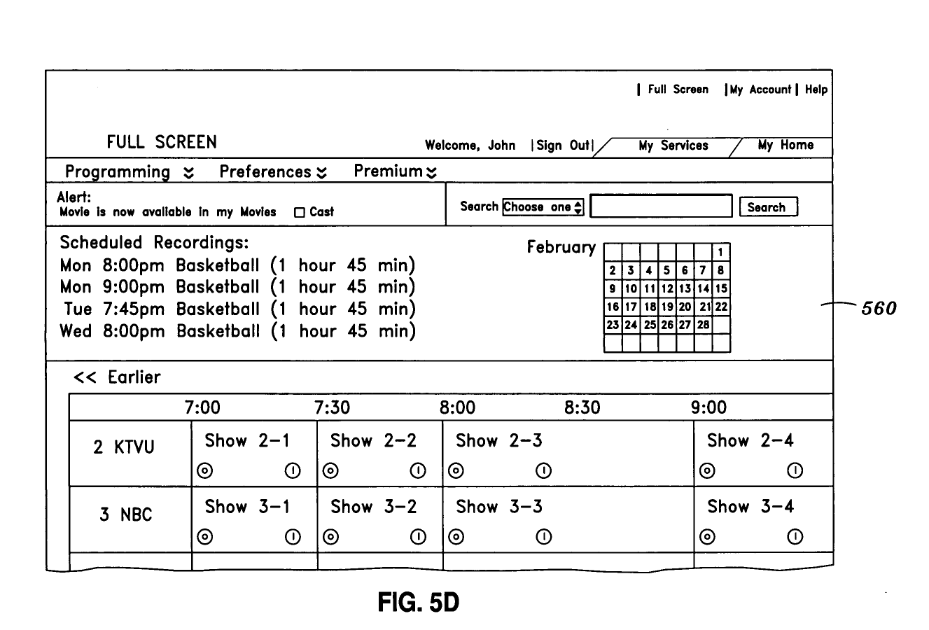

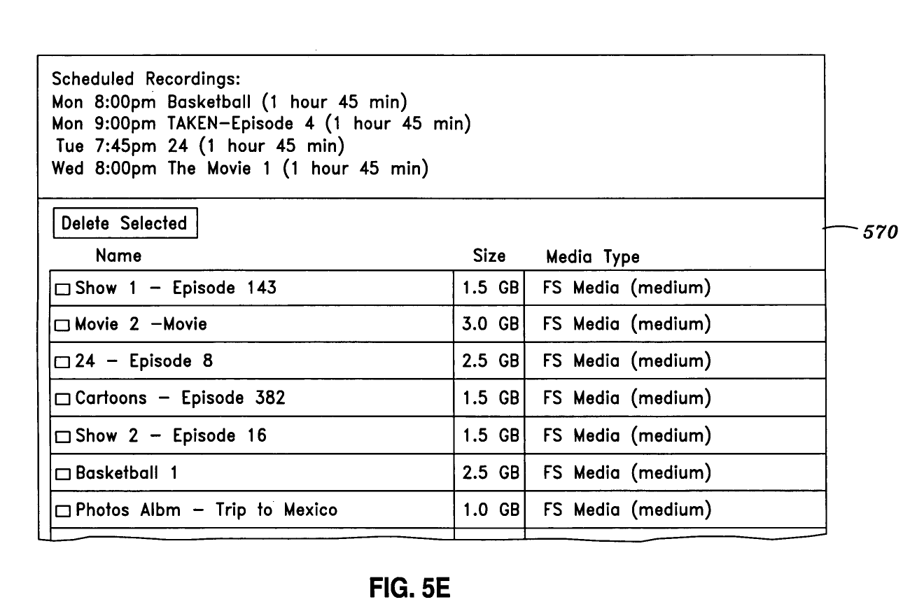

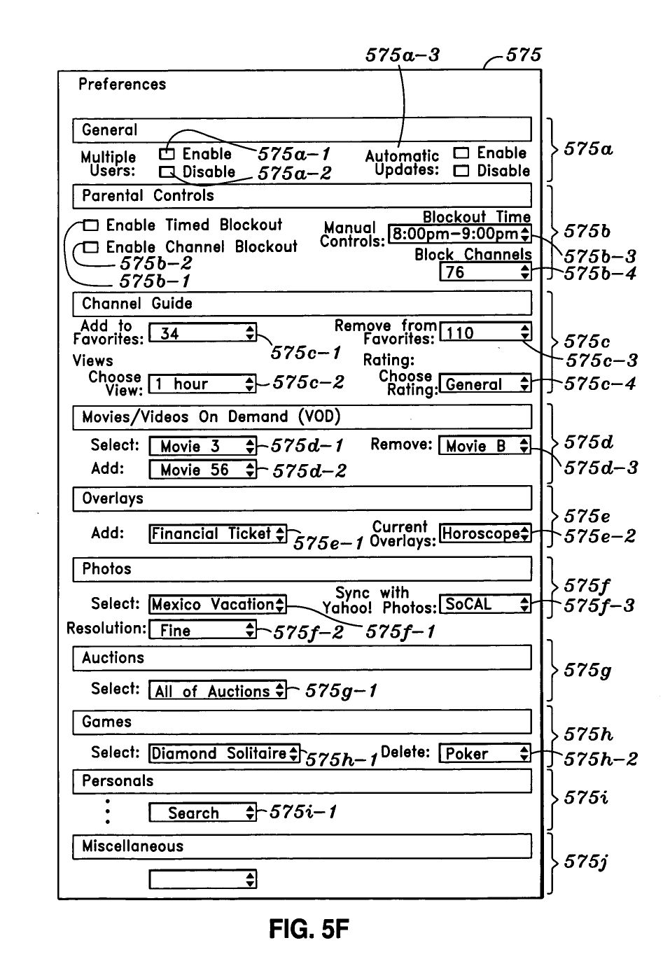

When a user ID is available it may be mapped to the client device ID previously supplied. In one embodiment, this is accomplished by a backend server 125 where a record of various client device ID's is maintained against various user IDs. This may further be configurable via a backend server system and appear as a preference as described in FIG. 5F. Irrespective of the implementation, the result is a many-to-one or a many-to-many mapping between user IDs and client IDs. This information can then be used to retrieve the user ID credentials given a client ID. At block 355, the user ID credentials may then be submitted to a database (e.g., stored on back-end server 125) for server-side authentication. At this point, the authentication process may be completed at block 360 when one or more cookies (or other appropriate means of identification) may be established and used to allow the underlying data/services request to be filled. It should of course be understood that there are numerous other methods for authenticating a client device that are consistent with the principles of the invention.

Referring back to FIG. 3A, once the authentication process of block 315 is complete, request process 300 may then continue to block 320 where the user is actually authorized by the server-side system to receive/view the requested data/services. Since at this point, the type of client device involved will be known, it is possible to customize service/data-offerings for a particular type of device (e.g., no streaming video available for devices which do not support that feature, etc.). Data/service delivery may then take place (block 325).

In one embodiment, the Service Adapter 220 may provide data in a stream format based on the specific client request. By way of example, one potential request may be a request for XML data, in which case data may be delivered in XML format. Where the request is for HTML data, the requested data may be delivered in HTML format and combined with the application UI and logic flow. In one embodiment, the application UI and logic may be an HTML page with data appropriately positioned within it. For example, this may be a stock quotes HTML page that renders an overlay over existing broadcast content. Similarly, custom data streams may also be delivered via the Services Adapter 220 for client-side devices that are capable of parsing data streams that are arbitrarily delimited (e.g., comma separated values, etc.). The process logic framework 245 and/or the service adapter 220 may do whatever is necessary to deliver the service to the user, based on knowledge of the capabilities of the device as derived from block 320.

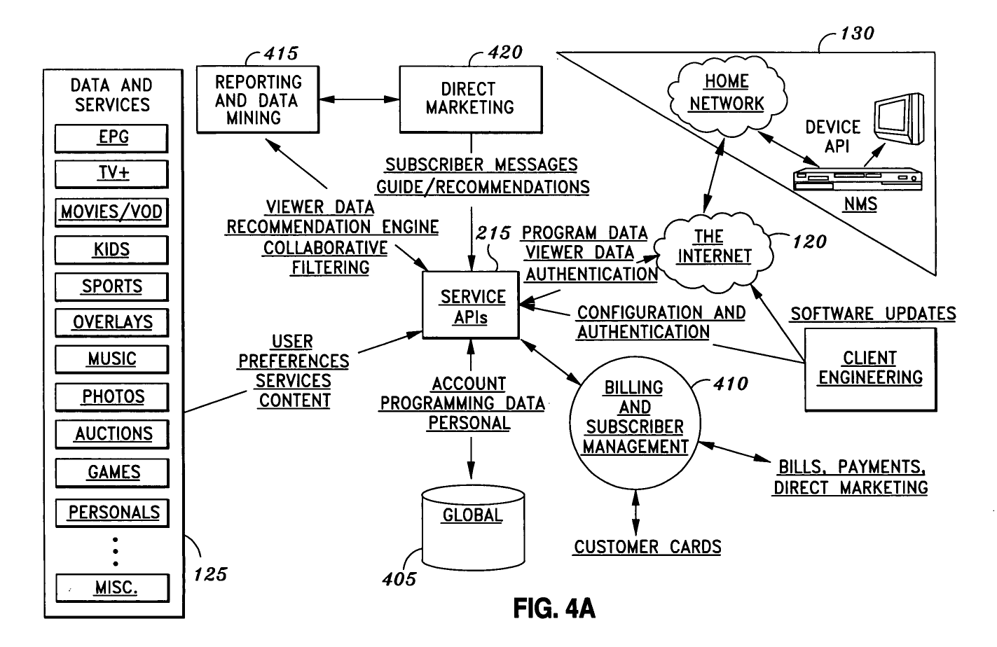

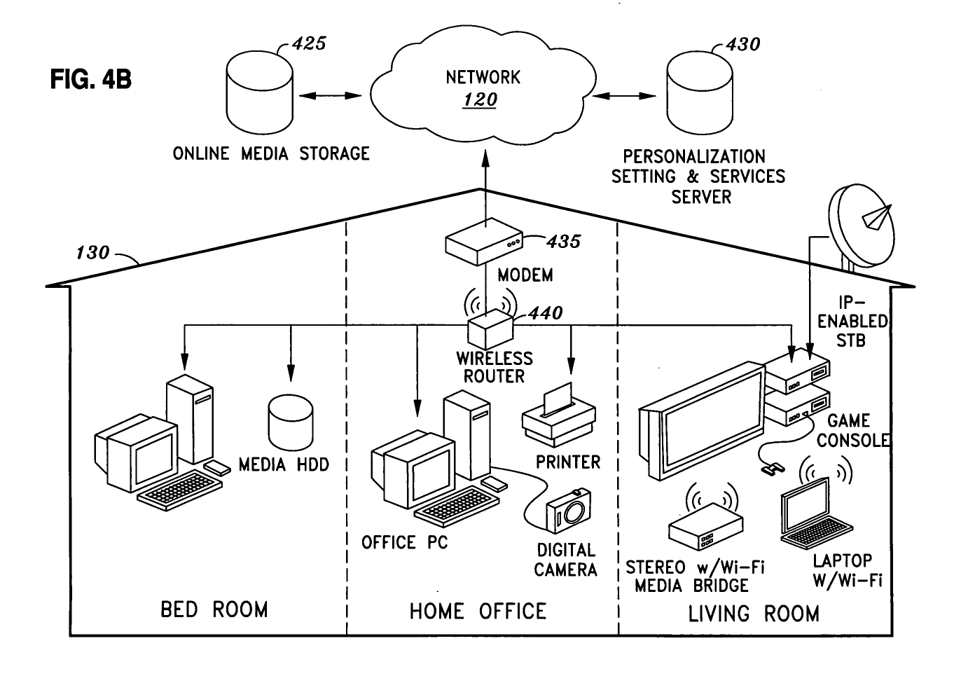

Referring now to FIG. 4A, one embodiment of a system-level diagram showing the interconnectivity of various aspects of the invention is depicted. In this embodiment, Services API 215 is shown as being in communication with network 120 (i.e., the Internet), client-side system 130 and back-end server(s) 125. Additional optional back-end systems are also depicted (e.g., reporting and data mining, direct marketing, billing and subscriber management, etc.).

As shown in FIG. 4A, back-end server 125 may contain various data/services which may be requested by the client-side system 130 as detailed above in FIGS. 3A-3B. In one embodiment, such data and services may include some form of an Electronic Programming Guide (EPG), TV+, movies or video on demand, kids' programs, sports (including but not limited to fantasy sports), overlays (including but not limited to data and voice overlays), music, photos, auctions, games, personals and other items as may be appropriate for a given device. The nature and type of services delivered may be customized for that device given a prior understanding of its capabilities as identified in block 320 (see FIG. 3A). In addition to requesting data/services, the Services API 215 may be used to obtain user preferences and/or identification information from the back-end server 125. In one embodiment, such data/services may include user preferences related to the data/services described above.

In one embodiment, the Services API 215 (via the Services Adapter 220—see FIG. 2A) performs the authentication functionality by mapping supplied device and user identification information against stored existing values. While in one embodiment, user/device ID information may be stored on back-end server 125 as mentioned above, it may also be stored on a separate user database 405 that may managed by a third party service provider.

As also shown in FIG. 4A, the Services API 215 may further be used to manage other user requests, such as billing and subscription inquiries (410). Similarly, the Services API 215 may be used to facilitate data mining functionality (415) and to interface client-specific advertising content for direct marketing purposes (420). It is to be appreciated that given the identity of the user (e.g., from the client device ID), the preferences and personalized services as they apply to the user on the network can now be directly applied to this same user on any device that can be identified with the user. In this fashion, a user may transfer their personalization and individualism across devices and mediums. That is, once the preferences and/or personalized services have been specified and entered as described above, the user may choose to apply his/her preferences and/or personalization to use services accessible and/or provided by or through any device that is connectible or connected to the network. Such devices may include hand-held devices, such as personal digital assistants (PDAs), telephones, personal computers, notebooks, set top boxes, digital media receivers or other connected devices. Further, all infrastructure and services that are used to provide the online experience may be applied towards their multimedia experience.

It should also be appreciated that the network 120 may be the Internet, or may also be a wide area network, a local area network or any other type of connection. In one embodiment, all that is required is that the client-side device 130 be appropriately connected to a service adapter 220 that is capable of providing a service to the device. It should further be appreciated that the above-described functionality for Services API 215 may be divided between a plurality of APIs and/or a plurality of back-end servers.

FIG. 4B is another embodiment of system-level diagram showing the interconnectivity of various aspects of the invention. In this embodiment, the functionality of back-end server 125 has been allocated between online media storage 425 and personalization settings & services server 430. With online media storage 425 and server 430 coupled to network 120, a user can access/request various data/services from a client-side system 130 (e.g., via modem 435). In this embodiment, the client-side system 130 comprises a bedroom portion, a home office portion and a living room portion. In one embodiment, a wireless router 440 may be used to interconnect the various client-side systems. It should of course be appreciated that the particular devices depicted in FIG. 4B that comprise the client-side system 130 are illustrative only, and numerous other configuration are equally consistent with the principles of the invention.

Referring now to FIG. 5A, a relational diagram 500 is depicted showing some of functions and services that may be accessible through GUI 110, which in one embodiment is a Web page. From the GUI 110 of FIG. 5A, a user may set preferences for content overlays 505, EPG settings 510, games 515, fantasy sports 520 and various other content- and services-related settings as depicted in FIG. 5A. From GUI 110, an online user can navigate the various functions and/or services to set or modify user preferences for the non-broadcast content/services accessible through client-side device 130. One embodiment of an interface usable to provide user preferences for the non-broadcast content/services is described in co-pending U.S. patent application Ser. No. ______, entitled “System and Method for Providing a User Interface,” filed on Jan. 6, 2004, which is assigned to the assignee of the present application, and incorporated herein by reference.

FIG. 5B depicts one embodiment of GUI 110 that may be used to enter user preference information, browse available online features and make content selections. In this embodiment, GUI 110 includes a content display window 525, a selection menu 530 and a feature window 535. Content display window 525 may be used to display information regarding available content (e.g., music, videos, pictures, etc.), or may be used to display the content itself. Selection menu 530 may similarly be used to select among available content options, while feature window 535 may be used to display features options to a user for selection by the user.

FIG. 5C illustrates another embodiment of the online user interface of FIG. 5A. The online user interface or graphical user interface 110A of FIG. 5C may be used to enter user preference information, browse available online features and make content selections. In this embodiment, GUI 110A includes a content display window 525A, a first selection menu 530A, a feature window 535A, a services/content window 540, a second selection menu 545 and a third selection menu 550. Content display window 525A may be used to display information regarding available content (e.g., music, videos, pictures, etc.), or may be used to display the content itself. First selection menu 530A may similarly be used to select among available content options, while feature window 535A may be used to display features options to a user for selection by the user. Services/content window 540 may be used to display various services or content available for selection, such as Fantasy Sports 540a, music 540b, photos 540c, movies 540d, or other services 540e. The second selection menu 550 facilitates selection of programming features 545a, user preferences 545b or premium features or services 545c. Additional features may of course be provided for selection. The third selection menu 550 may be used to provide prompts or alerts, such as an indication that a movie is not available for selection under the movies menu 530A. The third selection menu 550 may also include a window for conducting searches 550b.

FIG. 5D illustrates one embodiment of the Electronic Programming Guide provided through the use of the online user interface of FIG. 5C. Upon selection of the programming feature 545a, a scheduled selection window 560a may be displayed on the GUI 110. The scheduled selection window 560a comprises recording window 560a illustrates the movies or programs that have been selected for recording, along with the dates and times (start times and length of program) for recording. The window 560a also includes a calendar 560b and a programming guide 560c of the shows or movies available for recording. The user may select a move or program for recording using an input device (e.g., by selecting a key on a remote) and view his selections on the menu 570 as shown in FIG. 5E and described below.

FIG. 5E illustrates one embodiment of the Schedule Recordings provided through the use of the online user interface of FIG. 5C. The user may organize his or her selections for recording by viewing selection menu 570 as shown in FIG. 5E. The user may select programs or movies (along with the corresponding size and media type of the selection) displayed on the menu 570 to delete the corresponding movie or program.

FIG. 5F illustrates one embodiment of the Preferences menu provided in accordance with the online user interface of FIG 5C. Upon selecting the preferences window 545b on GUI 110, a preference menu 575 is displayed on the GUI 110. The preference menu 575 may include one or more preference menu sections 575a-575j for selecting or entering user preferences. In one embodiment, the preference menu sections 575a-575j comprise a General section 575a, a Parental Controls section 575b, a Channel Guide section 575c, a Movies/Video on Demand (VOD) section 575d, an Overlays section 575e, a Photos section 575f, an Auctions section 575g, a Games section 575h, a Personals section 575i, and other miscellaneous sections 575j.

Each of the preference menu sections 575a-575j may comprise one or more options for selecting preferences. These options may provide predetermined options which the user may scroll through and select. Alternatively, the user may specify his or her own preference(s). In the embodiment shown in FIG. 5F, the user is presented with a variety of predetermined options, which may be selected to enhance his or her viewing experience.

In the embodiment of FIG. 5F, the General section 575a may include options for enabling or disabling use by multiple users of any of the services or programs by selecting boxes 575a-1 or 575a-2 respectively. The user may also enable or disable the sending of automatic updates 575a-3. In this embodiment, the user may use an input device, such as a mouse, to click on the windows provided in section 575a to select his/her options.

Similarly, the user may make various selections under the Parental Controls section 575b. For example, the user may enable Timed Blockout and/or enable Channel Blockout through the selection of boxes 575b-1 and/or 575b-2 respectively. If selected, the user may specify the time period to block out and/or the channels to block out the time and/or channel through the use of selection box 575b-3 and/or 575b-4. In one embodiment, the user may scroll through the time periods and/or channels in the selection box 575b-3 and/or 575b-4 by clicking on the up or down arrow(s) provided to the side of each selection box 575b-3 and/or 575b-4.

Likewise, the user may enter his/her channel preferences by entering selections in the Channel Guide section 575c. In this embodiment, the user may add channels to his/her list of favorite channels, selecting the viewing period, remove channels from his/her list of favorite channels and/or select the ratings for viewing. This may be accomplished through the use of selection boxes 575c-1, 575c-2, 575c-3 and/or 575c-4 respectively. As described earlier, the user may scroll through the selection boxes 575c-1, 575c-2, 575c-3 and/or 575c-4 by clicking on the up or down arrow(s) provided on the side of each selection box 575c-1, 575c-2, 575c-3 and/or 575c-4.

Movies and/or Videos on Demand (VOD) may also be selected using preference selection section 575d. The user may select, add or remove movies or videos by entering selections available in boxes 575d-1, 575d-2 and/or 575d-3. As before, the user may scroll through the selection boxes 575d-1, 575d-2 and/or 575d-3 by clicking on the up or down arrow(s) provided on the side of each selection box 575d-1, 575d-2 and/or 575d-3.

Overlays may also be added for viewing by the user. In preference selection section 575e, the user may choose from a list of overlays, such as weather information, financial tickers, horoscopes, etc. provided in selection box 575e-1. Current overlays are displayed in box 575e-2, where the user can parse through a list a overlays that have been selected for viewing. When viewing the display screen, the user may activate this feature through the use of an input device such as a remote controller or through selection of a button or key on the front panel of the display device.

Photos may likewise be selected for viewing, as shown in preference selection box 575f. The user may select a specific photo or group of photos, or other pictures, images, data, information, graphics or content, for viewing.

The user may participate in auctions. To do so, he or she may select to participate by selecting options available in the selection box 575g-1 under the preference selection section 575g. The options available may be “none”, an auction site or other auction options.

Games are also available to the user. By reviewing and selecting the options available under preference selection box 575h, the user may select to one or more games for playing, through selection box 575h-1. The user may also delete previously selected games by parsing through and selecting games listed in selection box 575h-2. The user may also select to participate in Personals, as shown in preference selection box 575i. To do so, the user may select options available in selection box 575i-1. Other preferences may similarly be provided to the user through selection section 575j, to enhance the user's experience. It is understood that one or more of the above selection sections may be implemented. In addition, a greater number of selection sections may also be implemented.

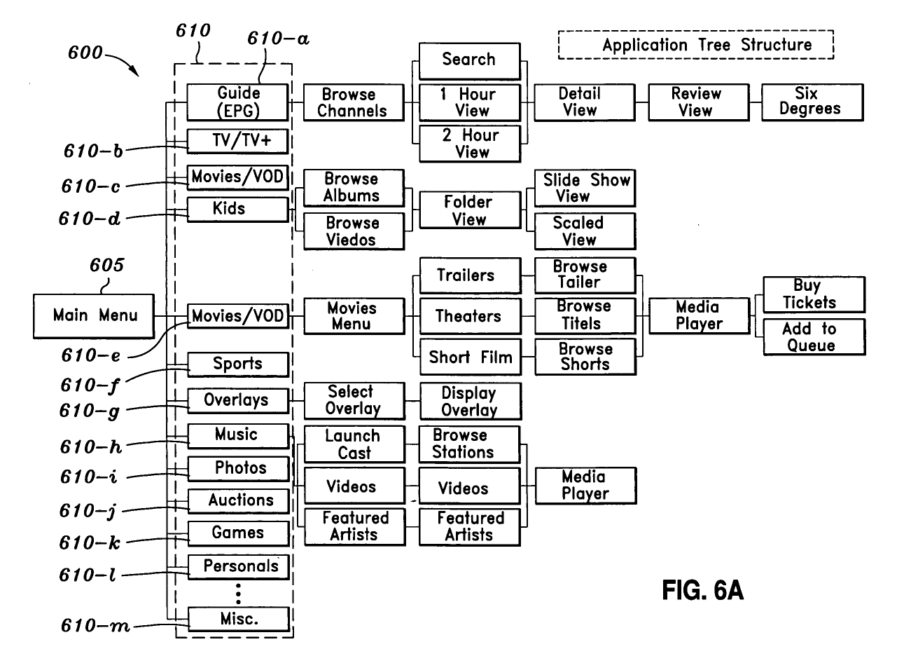

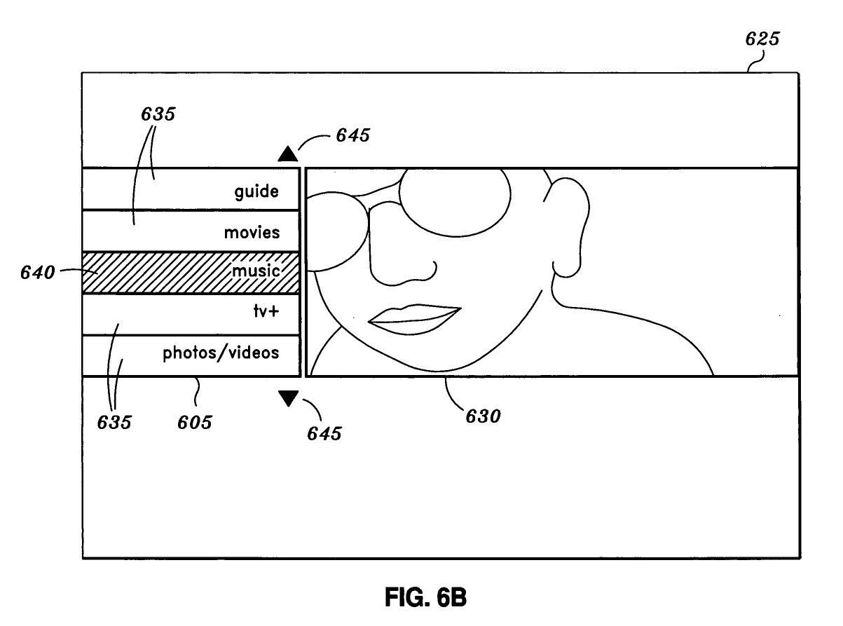

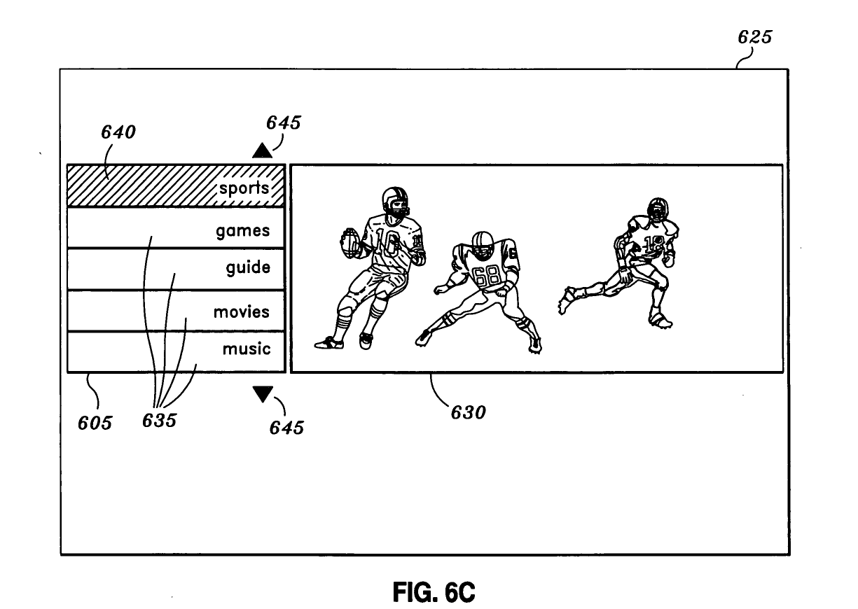

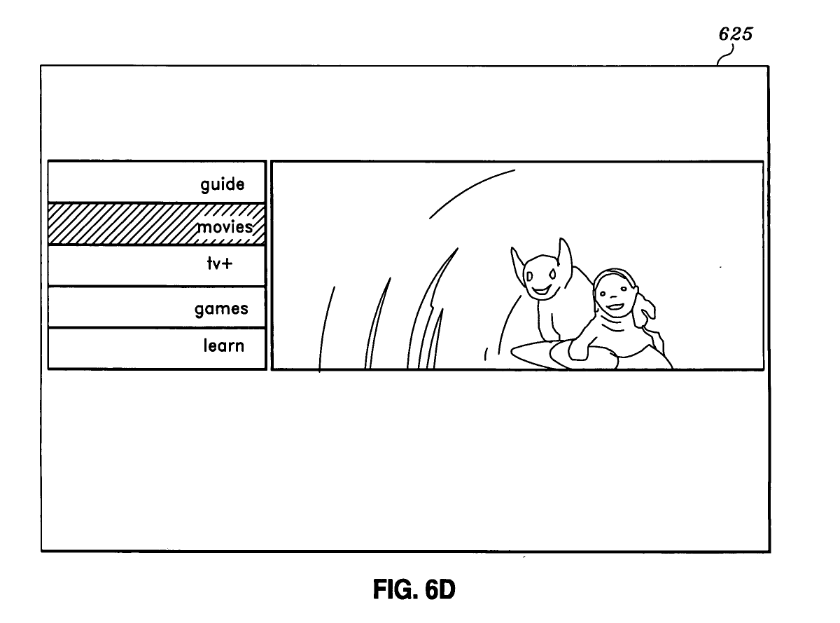

Once preferences have been determined, the user may access functions/data/services via a client-side device 130. Referring now to FIG. 6A, depicted is one embodiment of an application tree structure 600 for the functions/data/services that may be accessible to a user via a client-side device 130. As shown in FIG. 6A, main menu 605 will contain various selection options for a user to be able to access available data/services, including but not necessarily limited to non-broadcast data. In the embodiment of FIG. 6A, these selection options are the first set of sub-level menus 610, which includes a Guide, such as an Electronic Programming Guide (EPG), TV+, Movies/VOD, Kids programs, Sports (such as Fantasy Sports), Overlays (such as Data Overlays), Music, Photos, Auctions, Games, Personals, and Miscellaneous menus. For example, by selecting to view the EPG sub-level menu 610-a, users may browse channels and search for particular broadcast programing using the lower-level menus. Similarly, by selecting the TV+sub-level menu 610-b, users may select to watch various outtakes on television programs; by selecting sub-level menu 610-c, users may select to watch movies and VODs; by selecting sub-level menu 610-d, users may select to watch Kids' programs; by selecting sub-level menu 610-e, users may select to view and/or participate in various sports programs, for example, fantasy sports. In addition, by selecting the Overlays sub-level menu 610-f, users may view various overlays, such as financial information, weather information, horoscope, etc.; by selecting the Music sub-level menu 610-g, users may view and/or listen to music; by selecting the photo sub-level menu 620 from the main menu 605 a user may browse their photo albums, videos, etc.; by selecting any of the Auctions, Games and/or Personals sub-level menus 610-i, 610-j and 610-k, the user may: participate in one or more auctions, play games or view/participate in personals, respectively. The application tree structure 600 of FIG. 6A is but one embodiment of how a user may navigate through the various available data/services on a client-side device 130. For example, one embodiment of how a user may navigate the application tree structure 600 or corresponding display screens is described in co-pending U.S. patent application Ser. No. ______, entitled “System and Method for Navigation of a Multimedia Interface,” filed on Jan. 6, 2004, which is assigned to the assignee of the present application, and incorporated herein by reference. Moreover, it should further be appreciated that additional functions/data/services may accessible using application tree structure 600, such as the embodiment of searching for content described in co-pending U.S. patent application Ser. No. ______, entitled “System and Method for Searching Content Using a Multimedia Interface,” filed on Jan. 6, 2004, which is assigned to the assignee of the present application, and incorporated herein by reference.

FIG. 6B depicts one embodiment of how main menu 605 may be presented to a user. In this embodiment, display screen 625 is displayed on some display, such as display screen 170 of FIGS. 1A & 1C or the display device 180 of FIG. 1B. In the embodiment of FIG. 6B, display screen 625 includes an optional graphic portion 630 as well as the main menu 605. As mentioned above, a user may use main menu 605 to select from a menu of available data/services (e.g., guide, movies, music, etc.). In one embodiment, user input device 190 may be used to highlight a particular menu entry for selection. In particular, a user may scroll through unselected menu options 635 to highlight a selected menu option 640. When the number of menu selection options is greater than a predetermined number of displayable options (which is five in the embodiment of FIG. 6B), a user may scroll through additional options using scroll buttons 645. Depending on the nature of the user input device 190, this may be accomplished by using the directional arrows of a remote control, or the directional keys on a keyboard. Similarly, once a desired option has been highlighted, a user may select the highlighted option using an enter key on a keyboard, a selection button on a remote or any other number of input options.

In the embodiment of FIG. 6C, a user has used scroll buttons 645 to scroll the selection menu up and highlighted what is now selected menu option 640. It should be appreciated that the menu selection options shown in FIG. 6A are exemplary options only.

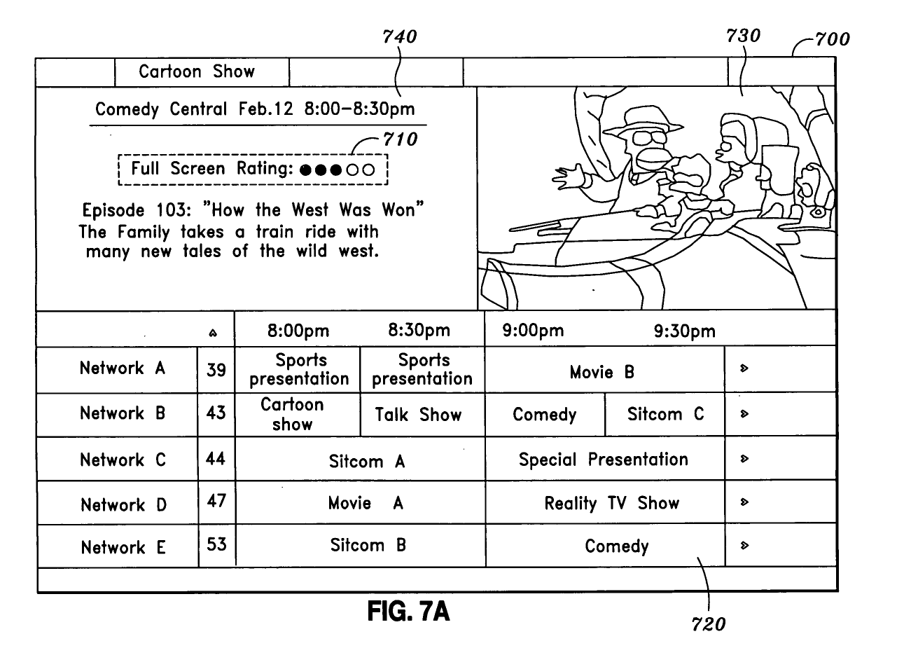

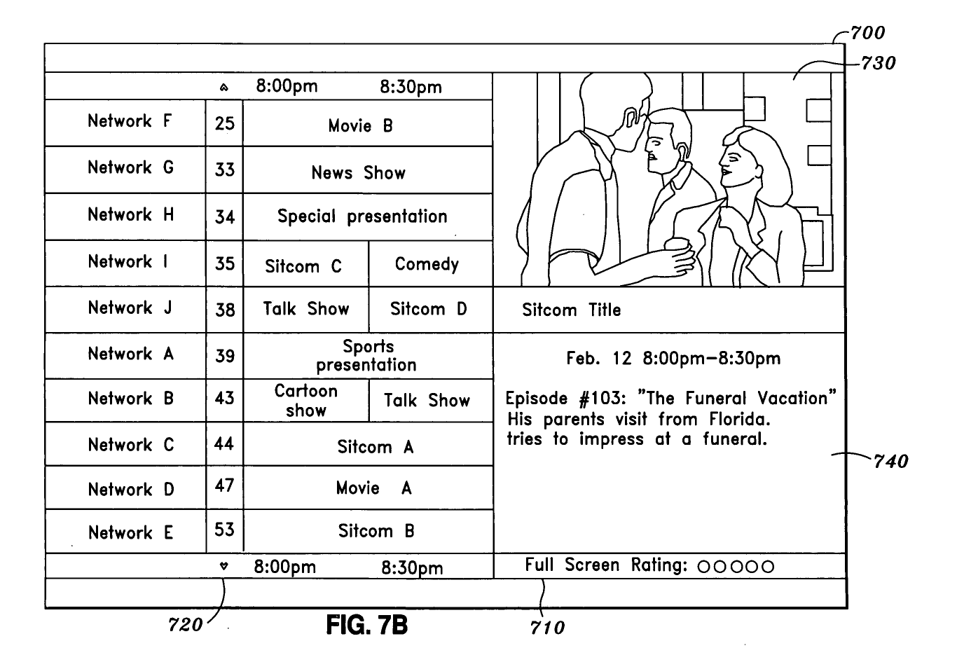

FIGS. 7A-7B depict embodiments of a program guide screenshot 700 which may be presented to a user who has selected the ‘guide’ option from main menu 605. In this embodiment, a user may receive movie programming/recommendation functionality on a broadcast display device (e.g., TV) based on online movie information. Rating information 710 that is based on non-broadcast content/data 115 may be displayed to a user simultaneously with electronic programming guide (EPG) information 720, along with broadcast content 730.

Continuing to refer to FIGS. 7A-7B, in one embodiment EPG 720 may be designed to allow users to navigate the programming schedule and select programs for viewing and recording. A list of networks and their associated channel numbers may be displayed, as well as some predetermined period of programming time (e.g., one hour, two hours, etc.). Users may navigate the EPG 720 using the arrow keys on a user input device 190 (e.g., a remote control) to highlight a program. As they highlight programs, related information may be displayed for each program including: name, description, network, date, run time, original air date and the show's rating information 710. It should be appreciated that the rating information 710 can refer to a critic rating or ratings by other consumers. Moreover, a user may be able to choose from a variety of rating options using the client-side device, or online using GUI 110.

The EPG 720 may also be community-based. Such community-based activity may involve live or recorded programs. For example, the user may select or identify certain programs and share their interest with the community. Such programs may be viewed live. Alternatively, if programs are selected to be recorded on a DVR, or if programs are selected to be saved on the DVR, then one's list of programs may be shared with a selected community. This may be accomplished without using an instant messenger platform or using the instant messenger buddy list. Thus, this enables one to share one's interests with a community (such as people who have the same interests).

Multimedia Interface Navigation

As mentioned above, users may navigate the program guide screenshot 700 using arrow keys on a user input device 190 (e.g., a remote control). For example, in the embodiment of FIG. 7A a user has navigated to the Comedy Show on Network B beginning at 8:00 pm. While in one embodiment, related information 740 for a highlighted program may be displayed, in another embodiment, such related information 740 is not displayed by simply navigating to a particular program. Rather, a user may need to perform an additional selection operation (e.g., pressing an ‘OK’ or ‘ENTER’ key) after having navigated to a program of interest.

Continuing to refer to FIG. 7A, in this embodiment the EPG information 720 is located at the base of the program guide screenshot 700, with the broadcast content 730 located in the upper right corner. Similarly, rating information 710 is shown as being positioned in the upper left corner. However, it should be appreciated that other program guide screenshot 700 configurations may be used. In particular, FIG. 7B depicts EPG information 720 along a left side of program guide screenshot 700, with broadcast content 730 situated above related information 720. In this embodiment, a user is able to view more channels at a time since the EPG information 720 spans the entire height of the program guide screenshot 700. In addition, rating information 710 is situated along a bottom bar rather than being incorporated into related information 740. Moreover, in this example a user has navigated to Network B to view Cartoon Show. Related information 740 and rating information 710 have been correspondingly updated.

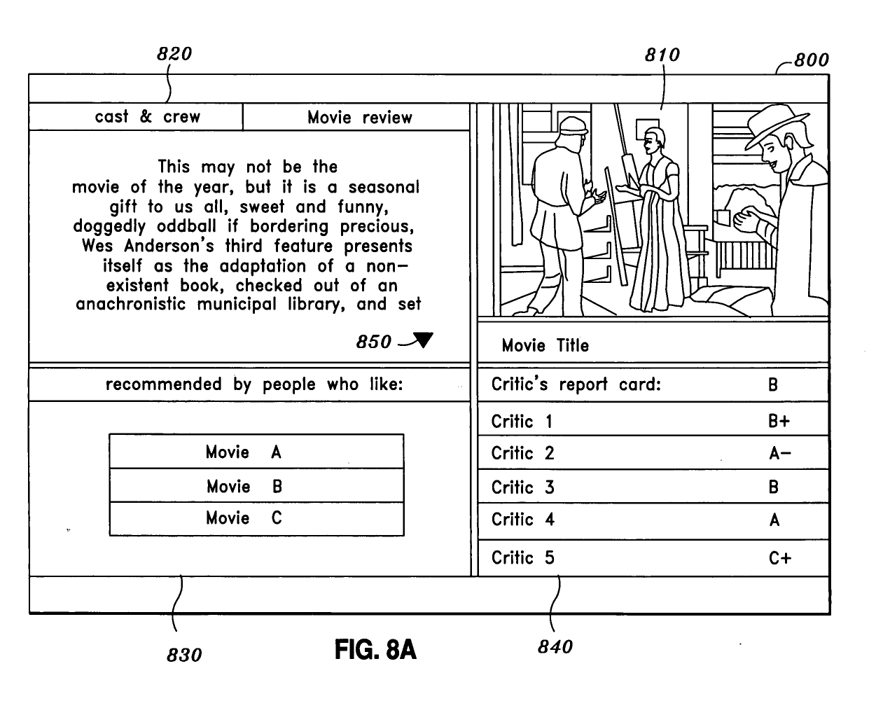

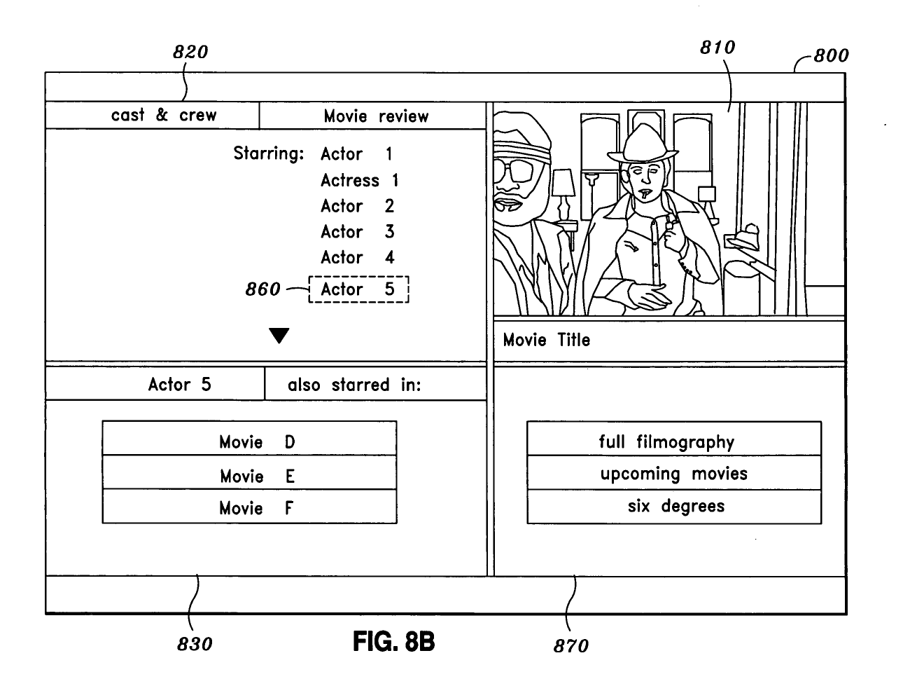

FIG. 8A is another embodiment of how broadcast and non-broadcast content may be navigated, and in particular screenshot 800 illustrates how detailed rating information 820-840 for broadcast content may be displayed to a user upon request. In one embodiment, a user may view screenshot 800 by navigating to and selecting the rating information 710 of FIGS. 7A-7B. As with previously discussed selection methods, it should be appreciated that numerous means for selecting the rating information 710 may be employed. For example, the navigation buttons of a remote control may be used to highlight the rating information 710, after which an ‘OK’ or “Enter’ button may be depressed to select it. A different specialized or programmable key may be similarly used to accomplish the same task. For example pressing a Red hot key on a remote to confirm the purchase, blue key to cancel. The use of a particular key for a given task and a presentation of its function in a GUI is determined by the capabilities of the device.

Once a user has chosen to view the more detailed rating information of screenshot 800, the broadcast content 810 and the various related rating information windows 820-840 are displayed as shown in FIG. 8A. While in this embodiment, broadcast content is situated in the top right corner of screenshot 800, it should be appreciated that other presentation configurations may similarly be employed. The presentation of a GUI is entirely dependant on the nature of the client device.

Regardless of the presentation configuration, detailed rating information may be presented to the user as shown in FIG. 8A. In the embodiment of FIG. 8A, the detailed rating information comprises a content description 820, a recommendation list 830 and a critic survey 840.

In this embodiment, the content description 820 is a text-based description of the broadcast content 810. Where the content description 820 is too long to view all at once, scroll button 850 may be used to scroll down to view the entire content description 820. On client devices that do not support scroll functionality, other methods such as arrows or other keys can be used to provide the same functionality. Moreover, in the embodiment of FIG. 8A, content description 820 has been broken into two categories: ‘cast & crew’ and ‘movie review’. In the embodiment of FIG. 8A, the ‘movie review’ category has been highlighted and selected and the content description window 820 has been filled with an actual review of the broadcast content 810.

On the other hand, the recommendation list 830 provides a list of additional content (e.g., movies) which may also appeal to the user. It should be appreciated that numerous means for implementing the recommendation list 830 may be used. For example, the content chosen for inclusion in the recommendation list 830 may be based on similar subject matter or genre. Alternatively, the list may be comprised of movies that have actors and/or directors in common with the broadcast content 810. Numerous other criteria for inclusion in the recommendation list 830 may also be used. Finally, the detailed rating information further comprises the critic survey 840, which may be a score-based compilation of one or more critic reviews.

In particular, the detailed rating information 820-840 is one embodiment of the non-broadcast content/data 115 that may be communicated to a client-side system 130 over a network 120. As previously detailed, a user may specify the nature of the non-broadcast content/data 115 (which is the detailed rating information in this embodiment) by setting certain user preferences entered via GUI 110. Once the client device is identified and associated with a User ID as described in 300, any manner of personalized content and associated preferences can be delivered to the device 130.

As previously described, it should be appreciated that rating information 820-840 may be provided via data plane 205 across an application service plane 230 comprised of a services adapter 220. In one embodiment, Services API 215 is charged with using previously defined user preferences to poll one or more online rating information sources, and to provide detailed rating information 820-840 in accordance with those user preferences.

Where user-defined preferences are used to customize the detailed rating information 820-840 of FIG. 8A, the request process 300 and authentication process 330 of FIGS. 3A-3B may be used to identify the user and transmit the non-broadcast content/data 115 according to the user's predefined preferences.

Referring now to FIG. 8B, depicted is another embodiment of screenshot 800. In this embodiment, the ‘cast & crew’ category has been selected and the content description window 820 has been filed with information pertaining to the cast and crew of the particular selected broadcast content 810. As with the other highlighting and selection operations described herein, a user may navigate from one option to another using the navigation buttons on a remote control or the directional keys of a keyboard. It should further be appreciated that other means of user input may similarly be employed.

Continuing to refer to FIG. 8B, with the ‘cast &crew’ category selected, the user is then able to navigate and select between the various actors and actresses listed in the content description window 820. To that end, the user has navigated to and selected Actor 5, as shown by reference arrow 860. By selecting Actor 5, recommendation list 830 is updated to display additional movies that Actor 5 has starred in, which in this embodiment is listed as Movie D, Movie E and Movie F.

In addition to updating recommendation list 830 with additional movies featuring Actor 5, additional information for Actor 5 may be displayed in window 870. In the example embodiment of FIG. 8B, this additional information has been divided into three choices: full filmography, upcoming movies and six degrees. In one embodiment, selecting the ‘full filmography’ option of window 870 would present the user with an overview of all movies that Actor 5 appeared in. Similarly, selecting the ‘upcoming movies’ option would display not-yet-released movies featuring Actor 5. Finally, in the embodiment of FIG. 8B, selecting the ‘six degrees’ option (which is explained in greater detail below) will enable a user to view relational data for actors, directors, etc.

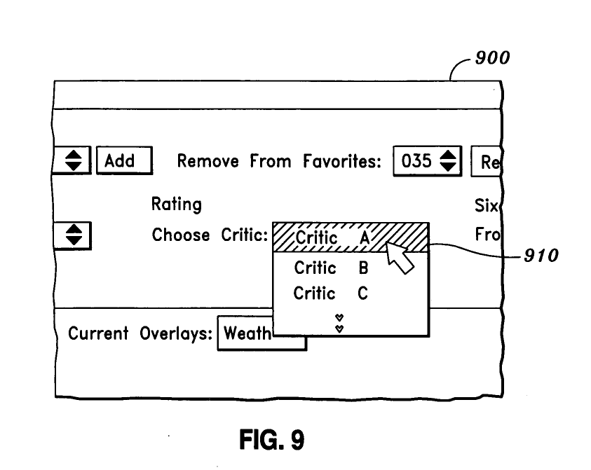

FIG. 9 depicts a portion of a graphical user interface (GUI) 900 which may be used to enter user preferences including, for example, preferences relating to critic reviews. In one embodiment, GUI 900 is a portion of GUI 110 (see FIG. 5B above) and may be used to enter user preference information, browse available online features and make content selections. In this embodiment, GUI 900 several preferences drop-down windows, one of which enables the user to select from a list of available critics. Namely, drop-down window 910 includes a list of available critics (i.e., Critic A, Critic B and Critic C). By positioning the cursor over a particular critic option and selecting it, a user can set critic preference information online, which may then be used to generate rating information 710 and detailed rating information 820-840, as discussed above.

Once a user has made a critic preference choice, third-party online sources (e.g., movie rating website, online article of movie critic, etc.) may be accessed to provide the non-broadcast content/data 115 needed to generate the rating information that conforms to the critic preference choice made online by the user.

Customization of Multimedia Interface

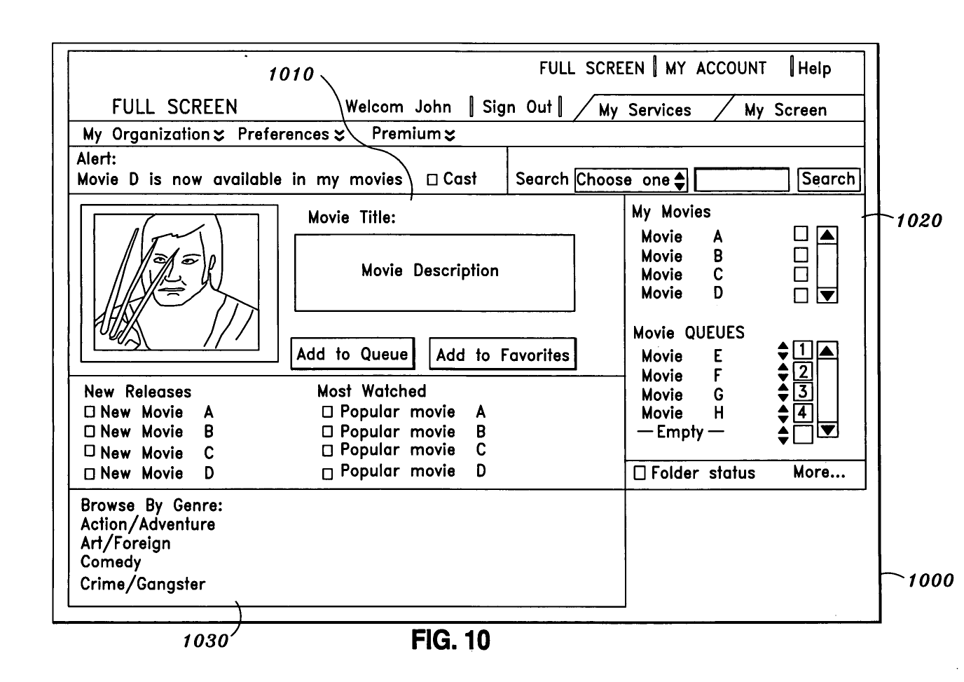

Another aspect of the invention is to provide a customizable multimedia interface. To that end, FIG. 10 depicts one embodiment of a GUI 1000 that may be usable to set user preferences for non-broadcast content/data 115 that may be communicated to a client-side system 130 over a network 120. In one embodiment, non-broadcast content/data 115 may include user-preference data, multimedia content and any other form of non-broadcast data, preferences for which a user may enter using GUI 1000. The user's customized preferences are used to deliver a highly personalized GUI interface and application to the device after first identifying the user and the device. This may be done as described, for example, in 300.

GUI 1000 may be one embodiment of previously discussed GUI 110. In particular, GUI 1000 includes a content display window 1010, which may be analogous to the content display window 525 of GUI 110. In addition, GUI 1000 also includes a selection menu 1020 and a feature window 1030.

In the embodiment of FIG. 10, content display window 1010 is used to display information regarding available movies, including such information as movie titles and descriptions. The particular movie information to be displayed in display window 1010 may be based on a user selection from selection menu 1020, or may be based on some other criteria, such as release date, popularity, etc. Moreover, as shown in FIG. 10, a user may be presented with the option to add the movie from display window 1010 to a queue for future recording/downloading. In one embodiment, a movie that has been selected for recording/downloading may be streamed to a client-side device 130 that is equipped with processing logic (e.g., processing logic 150) for provided the functionality of a DVR. Movie content may be provided to the client-side device 130 (which in one embodiment is a STB) as broadcast content, in which case the movie content is recordable by a DVR-enabled client-side device 130. Alternatively, movie content may be streamed to the client-side device 130 as non-broadcast content/data 115, in which case the movie content may be downloaded and stored to a non-volatile memory of the client-side 130.

Selection menu 1020 may similarly be used to select among available movies, including those that are currently available (e.g., My Movies), as well as those that are in queue to be recorded/downloaded (e.g., Movie Queue). It should be appreciated that selection of available options may be accomplished in numerous ways, including positioning of a mouse cursor over a desired option and clicking on a mouse selection button. Moreover, currently available movie options in one embodiment corresponds to those movies that have been previously recorded/downloaded by client-side device 130. In addition, movies placed in the queue of selection menu 1020 may be those movies that will be aired (or available for download) in the near future, and which the user has selected for recording/downloading.

The feature window 1030 of FIG. 10 is used to display various movie feature options to the user. In one embodiment, the feature window 1030 may be used to present the user with a variety of options for browsing movie content. For example, a user may be presented with a list of the newly released movies and the most popular movies. By selecting one of these movies display window 1010 may be updated with the information for the selected movie. At that point, a user could click on an “Add to Queue” button (or other selection means) to set the selected movie to be recorded/downloaded when aired or otherwise made available. Similarly, features window 1030 may be used to provide a user with other search capabilities, such as browsing movies by genre.

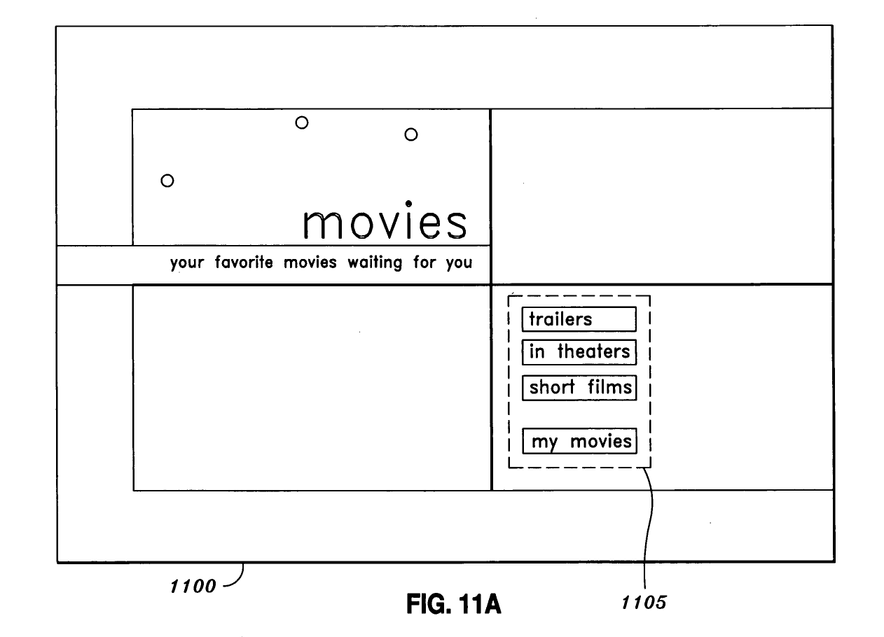

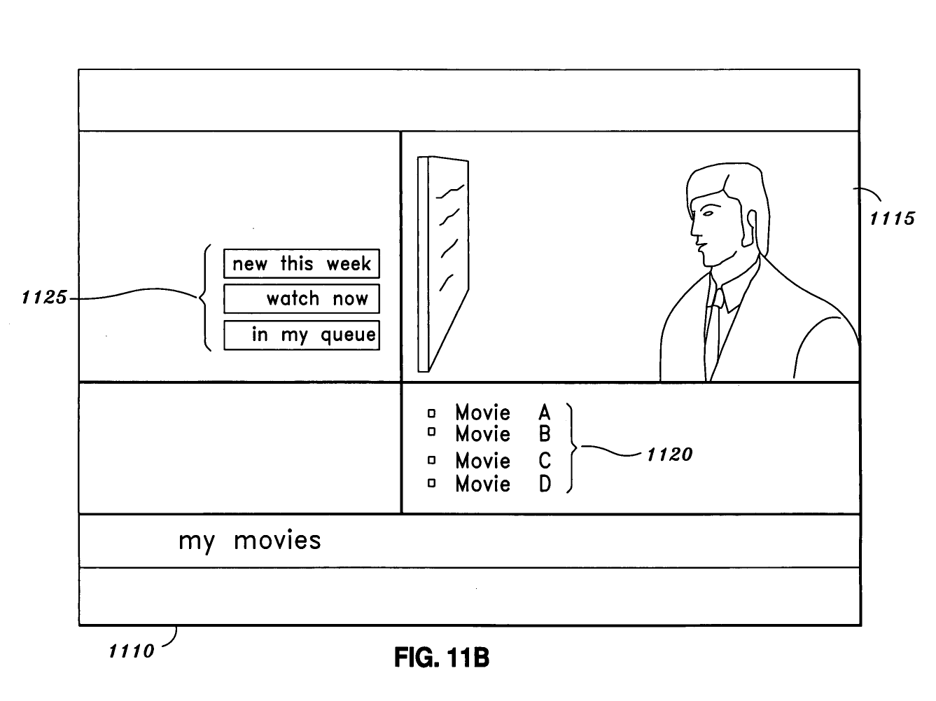

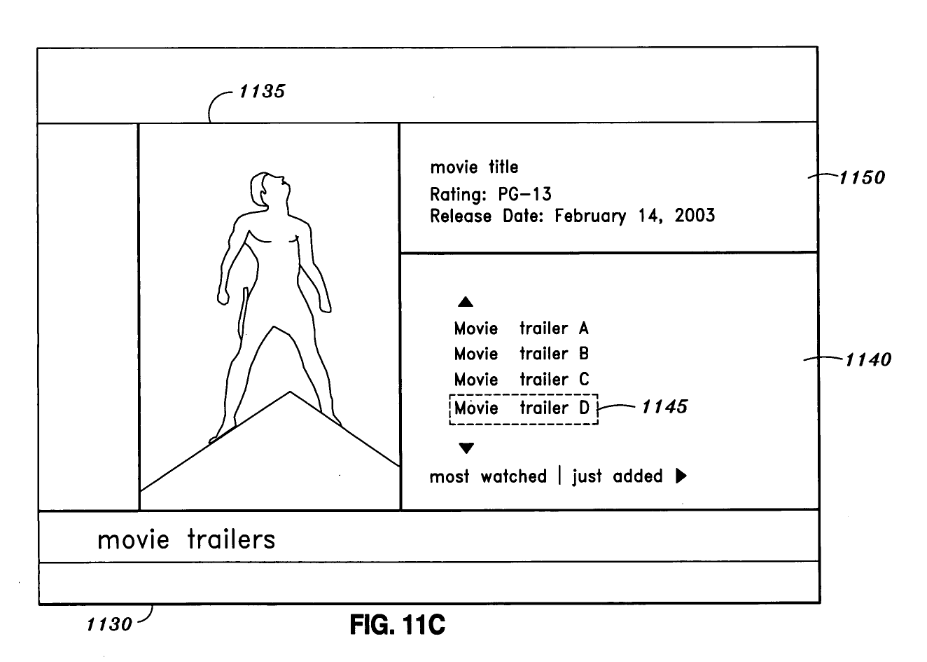

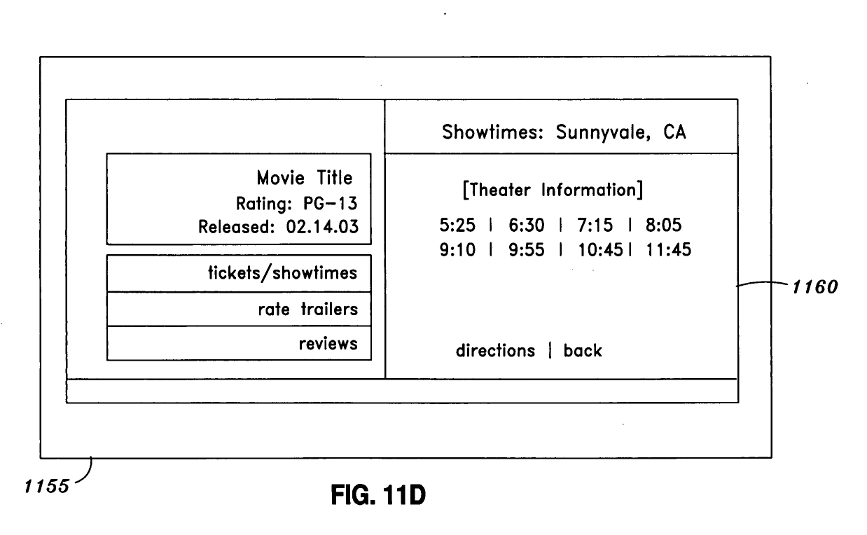

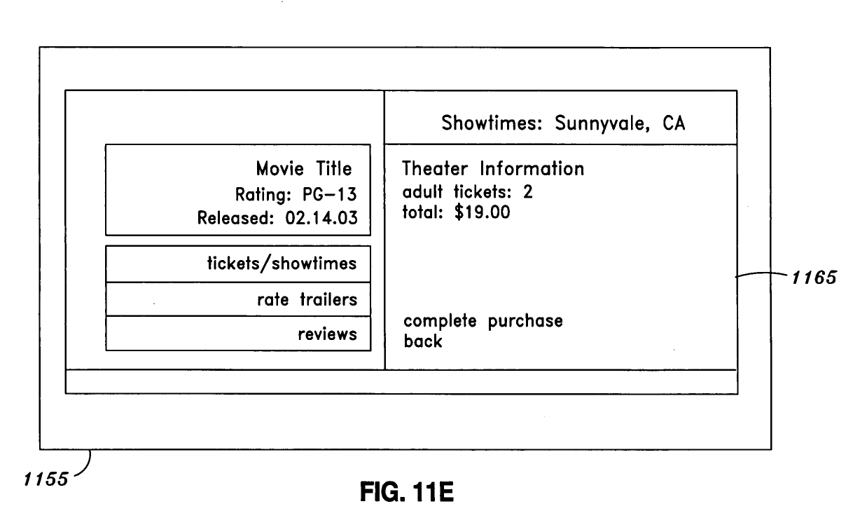

Referring now to FIGS. 11A-11E, depicted are screenshots that have been customized using the GUI 1000 of FIG. 10. These depicted screenshots may be presented by a client-side device 130 on a display, such as a television. With reference to FIG. 11A, a user may access screenshot 1100 using the application tree structure 600 via a client-side device 130. Regardless of how the user accesses screenshot 1100, a list of available options may be presented to the user as submenu 1105. In the embodiment of FIG. 11A, these submenu options are labeled as trailers, in theaters, short films and My Movies. In another embodiment, the options which comprise submenu 1105 may be customizable using GUI 1000.

FIG. 11B depicts one embodiment of a screenshot 1110 that may be presented to a user who has selected the ‘My Movies’ option from submenu 1105. In this embodiment, a display portion 1115 may contain a graphic or video of an available movie. In one embodiment, the movie content of display portion 1115 is associated with a user selection from movie menu 1120. In another embodiment, the movie content of display portion 1115 may be associated with a selection from option menu 1125.

Movie menu 1120 may be used to present movies that have already been recorded/downloaded to a client-side device. Thus, the list of movies in movie menu 1120 may be coextensive with the movies listed in selection menu 1020 under “My Movies”, according to one embodiment. In another embodiment, movies which have been moved to a queue to be recorded/downloaded may be viewed in the movie menu 1120 when a user selects the “in my queue” option from option menu 1125.

Referring now to FIG. 11C, depicted is one embodiment of a screenshot 1130 that may be displayed to a user who has selected the “trailers” option from submenu 1105. In this embodiment, a list of available movie trailers may be presented to the user in selection window 1140. It should be appreciated that this list may be sorted according to one or more criteria, such as by most watched or recently added. The criteria used to sort or select the available movie trailers may be set using GUI 1000 in one embodiment. Once a user has made a movie trailer selection, such as selection 1145, graphic 1135 and information window 1150 may be updated to correspond to the selection 1145. In one embodiment, a user may then elect to view the movie trailer of selection 1145 by selecting the updated graphic 1135, a portion of the information window (e.g., the movie title) or by selecting any number of other designated area of screenshot 1130.

FIG. 11D depicts yet another embodiment of a screenshot 1155 that may be accessible by a user via client-side device 130. In this embodiment, screenshot 1155 is accessible when a user has selected to view one of the movie trailers of selection window 1140 (e.g., Movie D—selection 1145). With the selected movie trailer playing, overlay 1160 may be displayed to the user either automatically or by the user manually requesting it. In the embodiment of FIG. 11D, the overlay consists of theater information.

The theater information of overlay 1160 may be determined from the preferences entered via GUI 1000. For example, in one embodiment a user selects a particular theater (e.g., closest to the user) based on zip code information. Available movies and show times for the selected theater may then accessed (e.g., via Services API 215) and streamed to client-side device 130. Additional services/information may also be made available based on previously-provided user preferences (e.g., via GUI 1000), including direction information to the theater, movie reviews, etc.

Once a user has selected a show time from the overlay 1160 of FIG. 11D, overlay 1165 of FIG. 11E may then be used to purchase tickets. In one embodiment, user credit information entered via GUI 1000 may be used to purchase movie tickets via the client-side device 130. In other embodiments, various online methods of purchasing may be incorporated into the functionality of client-side device 130. In this fashion, a user may select to view a movie trailer, access movie times from a predetermined theater location and even purchase tickets for the selected showing.

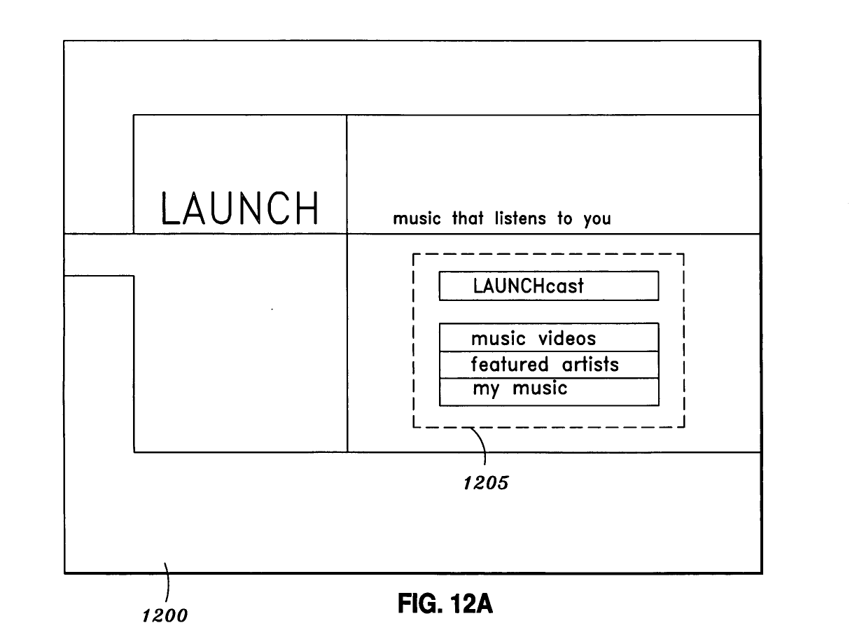

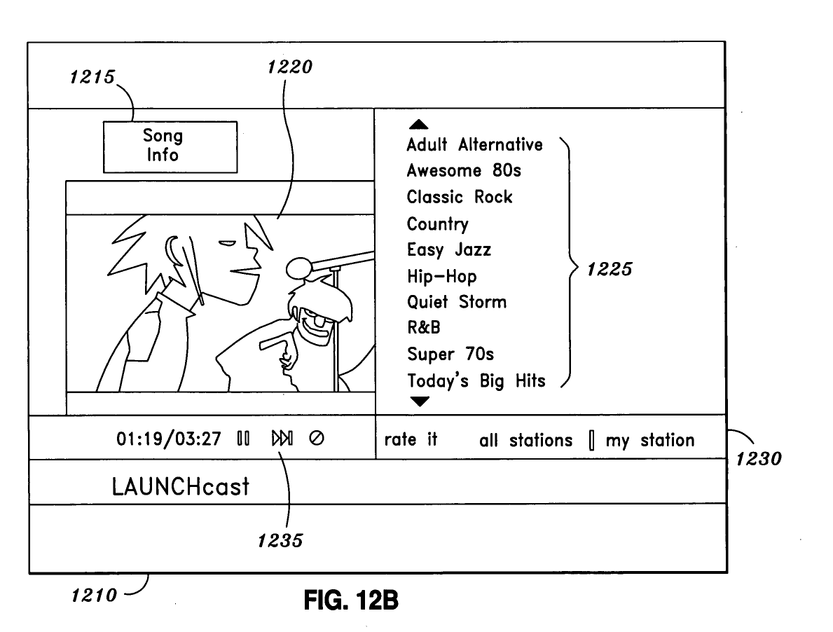

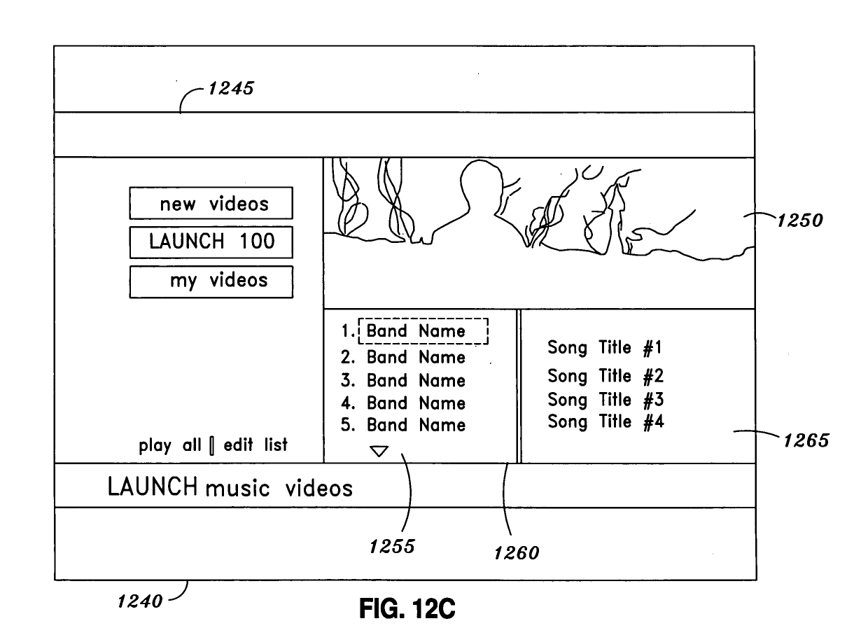

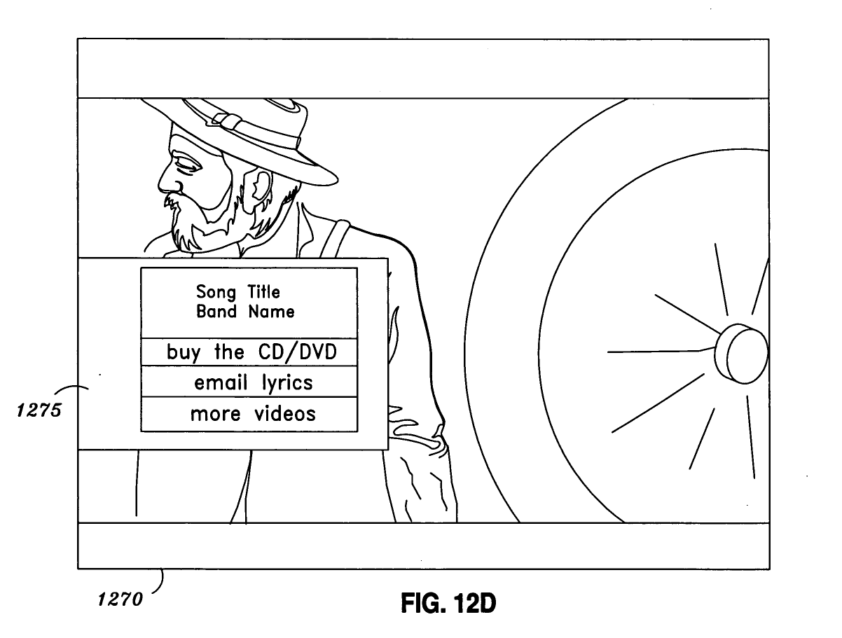

Referring now to FIGS. 12A-12D, depicted are screenshots that have been customized using the GUI 1000 of FIG. 10. These depicted screenshots may be presented by a client-side device 130 on a display, such as a television. With reference to FIG. 12A, a user may access screenshot 1200 using the application tree structure 600 via a client-side device 130. Regardless of how the user accesses screenshot 1200, a list of available options may be presented to the user as submenu 1205. In the embodiment of FIG. 12A, these submenu options are labeled as LAUNCHcast, music videos, featured artists and My Music. In another embodiment, the options which comprise submenu 1205 may be customized using GUI 1000.

FIG. 12B depicts one embodiment of a screenshot 1210 that may be presented to a user who has selected the ‘LAUNCHcast’ option from submenu 1205. In this embodiment, a display portion 1220 may contain a graphic or video representative of a selected music genre and/or song. Information for the selected music genre and/or song may be displayed in information window 1215. In one embodiment, the content of display portion 1220 and information window 1215 is associated with a user selection from genre menu 1225. As a user makes a selection from genre menu 1225, an associated music source (e.g., radio station) may be accessed and streamed to client-side device 130. For example, in the embodiment of FIG. 12B a user has selected “Adult Alternative” from the genre menu 1225. Using the control window 1235, a user can select to access the music source associated with the selection and hear the live feed from the music source. In another embodiment, the choices which comprise genre menu 1225 may be sorted using sorting window 1230. It should further be appreciated that, as with the previously discussed screenshots, genre menu 1225, information window 1215 and display portion 1220 may also be customized an online user (e.g., via GUI 1000).

As mentioned above, the accessed music source may be a radio station which is accessible online. For example, the content being aired by a radio station may be accessible online via a back-end server 125 that is also coupled to network 120. This content can then be selectively streamed to a client-side device 130 based on the preferences and selection made by a user. In one embodiment, user preferences for the genre menu 1225 and sorting options may be made via GUI 1000.

Referring now to FIG. 12C, depicted is screenshot 1240 which may be accessible by a user who selects the “music video” option from submenu 1205 of FIG. 12A. In this embodiment, selection menu 1245 can be used to tailor what content will fill band menu 1255 and/or video menu 1265. For example, by selecting “my videos,” band menu 1255 may be updated to reflect all available music videos that have been previously recorded/downloaded. Thereafter, a user can select a particular band, such as band 1260, which will then be used to populate video menu 1265 with songs by band 1260. Once video menu 1265 has been populated, a user is free to select from available videos. In another embodiment, upon a user making a selection from video menu 1265, display portion 1250 is updated to show a graphic or video clip corresponding to the user's selection.

In one embodiment, music videos available under the “my videos” option include videos that have been recording/downloading by a client-side device 130 that is equipped with processing logic (e.g., processing logic 150) for provided the functionality of a DVR. Video content may be provided to the client-side device 130 as broadcast content, in which case the video content is recordable by a DVR-enabled client-side device 130. Alternatively, the video content may be streamed to the client-side device 130 as non-broadcast content/data 115, in which case the video content may be downloaded and stored to a non-volatile memory of the client-side 130. Regardless of how the content is provided, GUI 1000 may be used to customize available content by, for example, favorite bands, favorite songs, genre, popularity, etc.

FIG. 12D depicts screenshot 1270 which, in one embodiment, is a music video accessible by a user who has made a selection from video menu 1265. In this embodiment, overlay 1275 may be selectively displayed by the user over screenshot 1270. In addition to containing information regarding the content being displayed, overlay 1275 may also be used to access additional services and/or content. For example, in the embodiment of FIG. 12D a user may opt to make a purchase, receive an email of the lyrics or access additional videos. These options, as with all of the previously discussed option menus, may be customized using GUI 1000 or another online user interface.

Searching Using a Relational Functionality

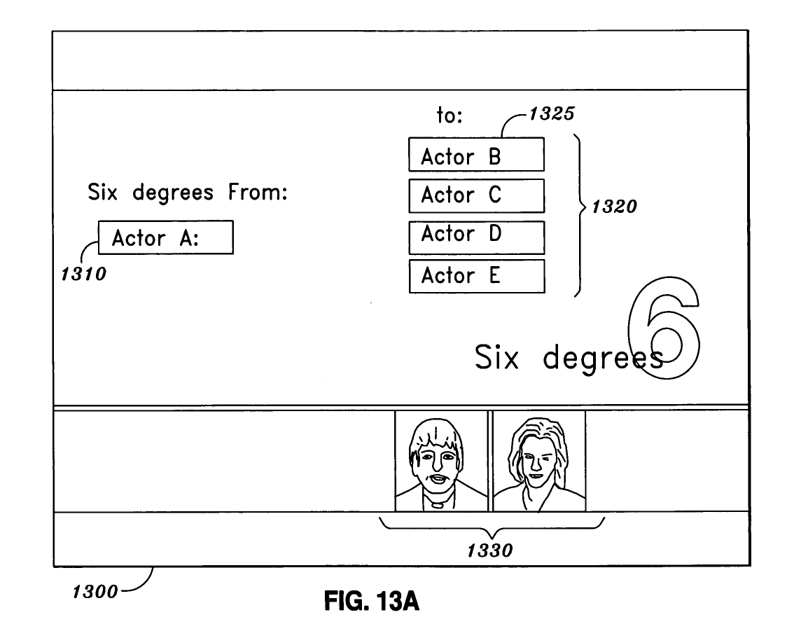

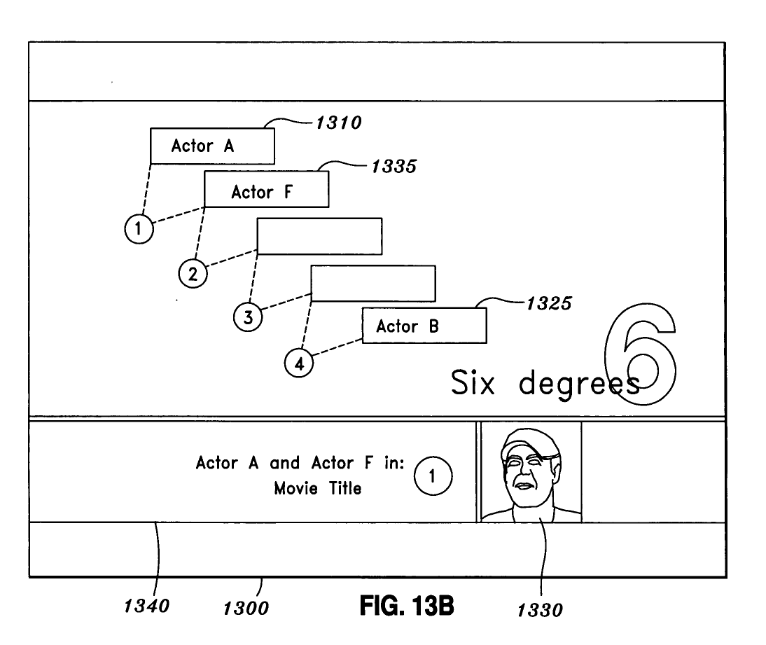

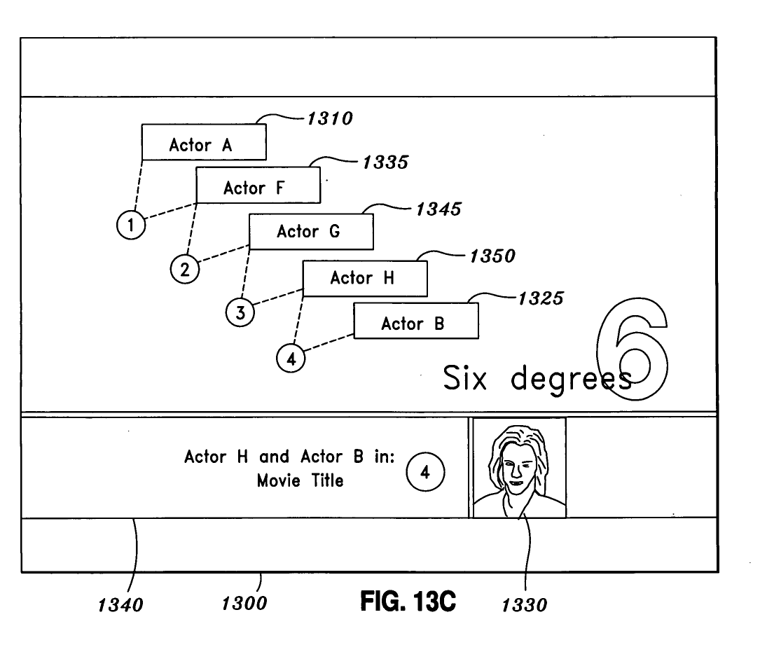

Another aspect of the invention is to provide content searching functionality for related content. In one embodiment, users are provided with a mechanism to search for indirectly related content and to watch it if it's currently available. For example, FIGS. 13A-13C illustrate one embodiment of how a user can enter a search starting point and ending point to access indirectly related movie content. Referring to FIG. 13A, the depicted screenshot 1300 may be used to enter a search starting point 1310 and select from a list of available ending points 1320. In the embodiment of FIG. 13A, the starting point 1310 and ending points 1320 are actors. However, it should be appreciated that other content criteria may be used, such as directors, producers, etc. In another embodiment, the search preferences for this user can be associated with their online profile. By identifying the user on the device as described in 300, it will be possible to directly apply the search conditions without any user input.

It should further be appreciated that a user may enter the starting point 1310 and select an ending point 1325 from a list of available ending points 1320 in any number of ways, including but not limited to the use of a keyboard connected to a client-side device or an on-screen keyboard that may be navigated using a remote control device. Regardless of how the starting point 1310 and ending point 1325 are entered/selected, graphic 1330 may be updated to reflect the entered data. For example, graphic 1330 may comprise photographs of the starting point 1310 actor (i.e., Actor A) and/or the ending point 1325 actor (i.e., Actor B).

Referring now to FIG. 13B, screenshot 1300 depicts the completion of a first step in establishing commonality information between indirectly related starting point 1310 and ending point 1325. In this embodiment, the first step between linking Actor A to Actor B is point 1335 (i.e., Actor F). Content details for the link between the starting point (i.e., Actor A) and point 1335 (i.e., Actor F) may then be displayed in information window 1340. In another embodiment, graphic 1330 may be updated with a photograph of Actor F.

FIG. 13C depicts screenshot 1300 after all steps have been completed for establishing the indirect relationship between starting point 1310 and ending point 1325, which in this embodiment is Actor A and Actor B. As shown in FIG. 13C, in addition to point 1335, points 1345 (Actor G) and 1350 (Actor H) establish the indirect relationship between the previously entered starting point 1310 and the selected ending point 1325. Moreover, information window 1340 and graphic 1330 may be updated to reflect this additional commonality information.

It should further be appreciated that once the search for the requested commonality information has been complete, in one embodiment the user may be provided with the opportunity to record/download one or more of the movies which comprise the content links between Actor A and Actor B.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A system comprising:
a user computer, coupled to a data network, to display a user interface usable to access a user account to enter a plurality of user customization preferences that are associated with said user account; and
a client-side device, coupled to the data network, to receive non-broadcast data from the data network and broadcast programming content from a broadcast source, said client-side device to,
access said plurality of user customization preferences from the user account via the data network;
display a plurality of media presentation options based on said plurality of user customization preferences from the user account,
access selected broadcast programming content from the broadcast source based on a user selection from said plurality of media presentation options.

2. The system of claim 1, wherein said data network is the Internet, said broadcast source is a television programming source, and said client-side device includes a set top box that is coupled to the Internet and to said broadcast source.

3. The system of claim 1, wherein said plurality of user customization preferences are stored in the user account and are accessible by providing at least one of a user ID and a password to said user interface.

4. The system of claim 3, wherein said client-side device accesses said plurality of user customization preferences by performing a logon operation to said user account.

5. The system of claim 1, wherein said plurality of user customization preferences includes at least one of selected movies to record, selected video content to download, selected music to download, content categories to list, content information to display, content purchase options, popular available content, and newly released available content.

6. The system of claim 1, wherein said plurality of media presentation options includes at least one of recorded available content, downloaded available content, clips of available content, trailers of available content, and movie theater information.

7. The system of claim 6, wherein when the selected broadcast programming content is available from the broadcast source, said client-side device records a broadcast of said selected broadcast programming content to a local memory of the client-side device.

8. The system of claim 7, wherein until the selected broadcast programming content is available from the broadcast source, said client-side device identifies the selected broadcast programming content as being in queue for future recording.

9. The system of claim 1, wherein the client-side device is further to display content purchase options based on said plurality of user customization preferences.

10. A method comprising:
entering a plurality of user customization preferences using a user interface displayed on a user computer that is coupled to a data network, wherein said plurality of user customization preferences are associated with a user account;
receiving, by a client-side device coupled to the data network, non-broadcast content from the data network and broadcast programming content from a broadcast source;
accessing, by the client-side device, said plurality of user customization preferences from the user account via the data network;
displaying, by the client-side device, a plurality of media presentation options based on said plurality of user customization preferences from the user account; and
accessing, by the client-side device, selected broadcast programming content from the broadcast source based on a user selection from said plurality of media presentation options.

11. The method of claim 10, further comprising coupling said client-side device to the data network and to the broadcast source, wherein said data network is the Internet, said broadcast source is a television programming source and said client-side device is a set top box.

12. The method of claim 10, further comprising:
storing said plurality of user customization preferences in said user account; and
accessing said user account by providing at least one of a user ID and a password to said user interface.

13. The method of claim 12, further comprising accessing, by the client-side device, said plurality of user customization preferences by performing a logon operation to said user account.

14. The method of claim 10, wherein said entering the plurality of user customization preferences includes entering the plurality of user customization preferences using the user interface where said plurality of user customization preferences includes at least one of selected movies to record, selected video content to download, selected music to download, content categories to list, content information to display, content purchase options, popular available content, and newly released available content.

15. The method of claim 10, wherein said displaying comprises displaying, by the client-side device, the plurality of media presentation options based on said plurality of user customization preferences from the user account, where said plurality of media presentation options includes at least one of recorded available content, downloaded available content, clips of available content, trailers of available content, and movie theater information.

16. The method of claim 15, further comprising recording a broadcast of said selected broadcast programming content to a local memory of the client-side device when said selected broadcast programming content is available from the broadcast source.

17. The method of claim 16, further comprising identifying, by the client-side device, the selected broadcast programming content as being in queue for future recording until the selected broadcast programming content is available from the broadcast source.

18. The method of claim 1, further comprising displaying, by the client-side device, content purchase options based on said plurality of user customization preferences.

19. A computer program product comprising:
a computer usable medium having computer program code embodied therein to display information, the computer program product having:
computer readable program code to enter a plurality of user customization preferences using a user interface displayed on a user computer that is coupled to a data network, wherein said plurality of user customization preferences are associated with a user account;
computer readable program code to receive, by a client-side device coupled to the data network, non-broadcast content from the data network and broadcast programming content from a broadcast source;
computer readable program code to access, by the client-side device, said plurality of user customization preferences from the user account via the data network;
computer readable program code to display, by the client-side device, a plurality of media presentation options based on said plurality of user customization preferences from the user account; and
computer readable program code to access, by the client-side device, selected broadcast programming content from the broadcast source based on a user selection from said plurality of media presentation options.

20. The computer program product of claim 19, further comprising computer readable program code to enable said client-side device to communicate with the data network and the broadcast source, wherein said data network is the Internet, said broadcast source is a television programming source and said client-side device is a set top box.

21. The computer program product of claim 19, further comprising:
computer readable program code to store said plurality of user customization preferences in said user account; and
computer readable program code to access said user account by providing at least one of a user ID and a password to said user interface.

22. The computer program product of claim 21, further comprising computer readable program code to access, by the client-side device, said plurality of user customization preferences by performing a logon operation to said user account.

23. The computer program product of claim 19, wherein said computer readable program code to enter the plurality of user customization preferences includes computer readable program code to enter the plurality of user customization preferences using the user interface where said plurality of user customization preferences includes at least one of selected movies to record, selected video content to download, selected music to download, content categories to list, content information to display, content purchase options, popular available content, and newly released available content.

24. The computer program product of claim 19, wherein said computer readable program code to display comprises computer readable program code to display, by the client-side device, the plurality of media presentation options based on said plurality of user customization preferences from the user account, where said plurality of media presentation options includes at least one of recorded available content, downloaded available content, clips of available content, trailers of available content, and movie theater information.

25. The computer program product of claim 24, further comprising computer readable program code to record a broadcast of said selected broadcast programming content to a local memory of the client-side device when said selected broadcast programming content is available from the broadcast source.

26. The computer program product of claim 25, further comprising computer readable program code to identify, by the client-side device, the selected broadcast programming content as being in queue for future recording until the selected broadcast programming content is available from the broadcast source.

27. The computer program product of claim 19, further comprising computer readable program code to display, by the client-side device, content purchase options based on said plurality of user customization preferences.
